(19) United States
(12) Patent Application Publication
(10) Pub. No.: US 2026/0289861 A1
(43) Pub. Date: Sep. 24, 2026

(54) SYSTEM

(71) Applicant: SoftBank Group Corp., Tokyo (JP)

(72) Inventor: Akira YOSHIDA, Tokyo (JP)

(73) Assignee: SoftBank Group Corp., Tokyo (JP)

(21) Appl. No.: 19/568,867

(22) Filed: Mar. 17, 2026

(30) Foreign Application Priority Data
Mar. 19, 2025 (JP) 2025-045181

(51) Int. Cl. G06T 11/60; G06F 16/2457; G06F 40/20; G06F 40/40; G06N 3/0475

(52) U.S. Cl. CPC G06T 11/60; G06F 16/24578; G06F 40/20; G06F 40/40; G06N 3/0475

(57) ABSTRACT

A system includes a processor that is configured to receive, from a first user, a prompt sentence for instructing a generative artificial intelligence model to generate a work based on a specific theme, enable participating users to cooperate in completing the work by inputting prompts to the generative artificial intelligence model, confirming generated works, and modifying the prompts as needed until the work is completed, and calculate popularity or attention of the generated works based on evaluations from users and numbers of views, and generate a ranking of the generated works.

### CROSS-REFERENCE TO RELATED APPLICATION

This application is based on and claims priority under 35 USC 119 from Japanese Patent Application No. 2025-045181 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for generating works using generative artificial intelligence models mainly support a single user issuing prompts to obtain generated content. In such systems, it is difficult for multiple users to cooperatively refine a work through iterative prompt modification while maintaining a shared theme, and it is also difficult to systematically evaluate and visualize the popularity or attention of the generated works. Furthermore, conventional systems do not adequately provide mechanisms for identifying and highlighting popular creators based on objective metrics such as user evaluations and view counts. In addition, existing systems generally do not recognize a user's emotional state and therefore cannot adapt generation instructions to the generative artificial intelligence model based on the user's emotion, which limits personalization and engagement. Accordingly, there is a need for a system that enables cooperative work creation using a generative artificial intelligence model, that calculates and ranks the popularity or attention of generated works, that highlights popular creators, and that recognizes user emotions to generate work instructions adapted to those emotions.

### SUMMARY

In order to solve the above-described problems, a system according to one embodiment of the present invention comprises a processor configured to receive, from a first user, a prompt sentence for instructing a generative artificial intelligence model to generate a work based on a specific theme, and to enable participating users to cooperate in completing the work by inputting prompts to the generative artificial intelligence model, confirming generated works, and modifying the prompts as needed until the work is completed. The processor is further configured to calculate popularity or attention of the generated works based on evaluations from users and numbers of views, and to generate a ranking of the generated works. The processor is also configured to display popular creators based on the ranking, thereby making it possible to emphasize creators who have produced highly evaluated works. Moreover, the processor is configured to recognize an emotion of a user and to transmit, to the generative artificial intelligence model, an instruction for work generation based on the recognized emotion, thereby enabling the system to adapt generation behavior to the user's emotional state and to provide more personalized and engaging cooperative creation.

The term “system” refers to an aggregation of hardware and software components including at least one processor and associated memory and interfaces, which collectively perform the functions described in the present specification and claims.

The term “processor” refers to one or more processing units, such as a central processing unit (CPU), graphics processing unit (GPU), digital signal processor (DSP), or other programmable circuitry, that executes instructions to perform the operations described in the present specification and claims.

The term “generative artificial intelligence model” refers to a trained computational model, such as a neural network or similar machine learning model, that generates content including, but not limited to, text, images, audio, video, or combinations thereof, in response to input data such as prompts or other instructions.

The term “prompt sentence” refers to a text input or other structured instruction provided by a user to the generative artificial intelligence model, which specifies a request, condition, or constraint for generating a work based on a particular theme or intention.

The term “work” refers to a piece of content generated by the generative artificial intelligence model, including, but not limited to, textual works, images, audio content, video content, or any combination thereof, which is associated with a specific theme or project.

The term “first user” refers to a user who initially provides a prompt sentence to the generative artificial intelligence model to generate a work based on a specific theme and who may initiate or define the context for cooperative creation.

The term “participating users” refers to one or more users, including optionally the first user, who cooperate in generating or refining a work by inputting prompts, reviewing generated content, and modifying prompts until completion of the work.

The term “cooperate in completing the work” refers to a process in which two or more users iteratively interact with the generative artificial intelligence model by providing prompts, receiving generated content, evaluating the generated content, and adjusting subsequent prompts with the shared objective of finalizing a work.

The term “specific theme” refers to a conceptual, stylistic, topical, or contextual subject, such as “future city” or “fantasy landscape,” that serves as a basis or constraint for the generation of one or more works by the generative artificial intelligence model.

The term “popularity or attention” refers to an indicator or metric representing the relative level of user interest, engagement, or approval of a generated work, which may be derived from quantitative data such as evaluations, ratings, or view counts.

The term “evaluation” refers to a user's explicit feedback on a generated work, including, but not limited to, numerical ratings, likes, votes, or other forms of scoring provided through the system's user interface.

The term “number of views” refers to a count of how many times a generated work has been accessed, displayed, or otherwise viewed by users through the system.

The term “ranking” refers to an ordered list of works or creators arranged according to a criterion such as popularity, attention, evaluations, or a calculated score derived from such metrics.

The term “popular creator” refers to a user who is identified by the system as having achieved a relatively high level of popularity or attention, for example based on aggregated evaluations, likes, or views of works generated or co-created by that user, and who is displayed with prominence in a ranking or dedicated interface.

The term “emotion” refers to an affective or psychological state of a user, such as happiness, sadness, excitement, frustration, or similar states, which can be inferred or recognized by the system using input signals including, but not limited to, textual input, voice, facial expression, physiological data, or behavioral patterns.

The term “recognize an emotion of a user” refers to processing input data related to the user and determining or classifying the user's emotional state using one or more algorithms, models, or rules.

The term “instruction for work generation” refers to data transmitted to the generative artificial intelligence model, including, but not limited to, prompts, parameters, constraints, or configuration values, that influence how the generative artificial intelligence model generates a work.

The term “based on the recognized emotion” refers to modifying or selecting at least part of the instruction for work generation, such as content of a prompt or model parameters, in accordance with the user's emotional state as determined by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

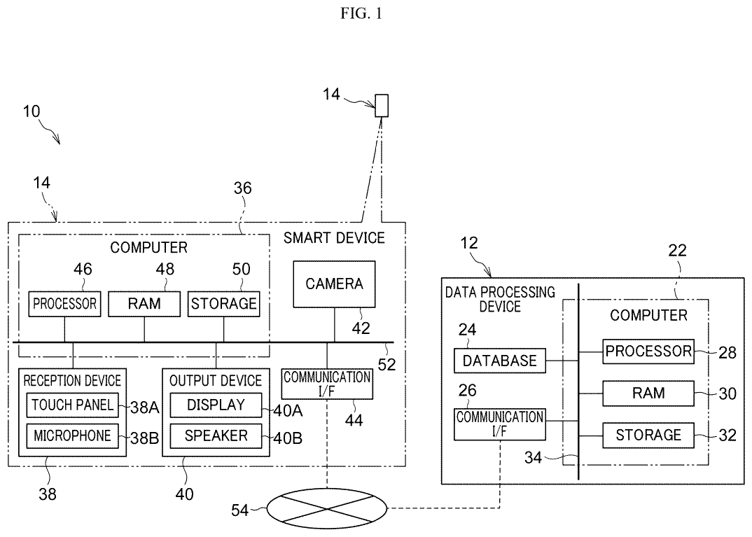

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

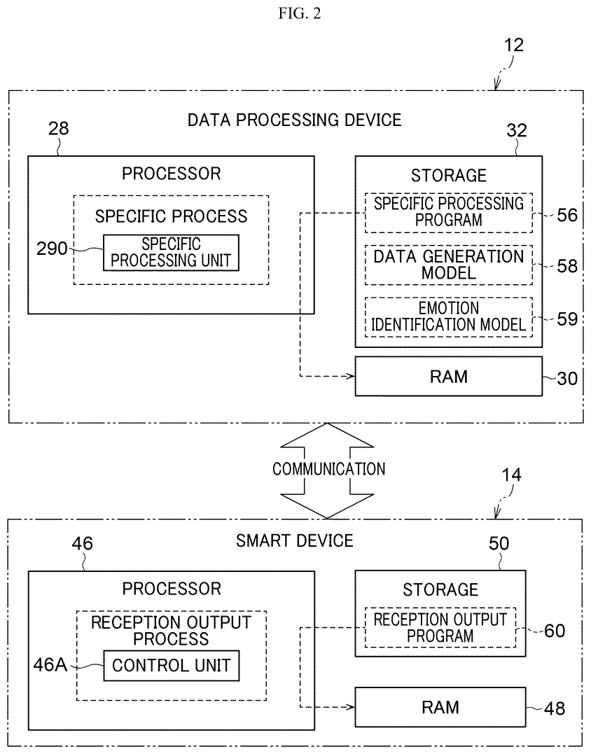

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content creation support systems using a generative AI model generally require a user to manually devise and refine a prompt sentence in order to obtain a desired output. Such systems typically treat the terminal-side input (for example, a theme or a rough description) and the model-side prompt sentence as almost the same text, and therefore fail to provide a systematic conversion from high-level creation settings into a machine-effective generation instruction structure. As a result, the burden on the user to repeatedly trial-and-error the prompt sentence is large, and the behavior of the generative AI model is highly dependent on the user's individual prompting skill rather than on a consistent computer-controlled process.

Furthermore, conventional systems rarely integrate iterative prompt sentence generation, automatic ranking of generated works, and emotional-state-based control into a unified processing pipeline. In many cases, popularity or trend analysis of generated works is performed offline, separated from the generation process, and is not fed back in real time to support the user's creative decisions. Likewise, even when user emotion or engagement is detected, such information is often used merely for user interface adjustments and is not used to directly alter generation conditions for the generative AI model in a structured manner. In addition, known systems do not sufficiently formalize the internal data processing flow in which the server interprets user-provided setting information, normalizes it, selects and fills a structured prompt template, converts the prompt sentence into generation instruction data, and manages iterative regeneration cycles. This lack of structured treatment leads to inefficiencies in server-side processing, difficulty in maintaining consistent quality across multiple users and sessions, and increased network traffic due to unnecessary or poorly targeted calls to the generative AI model.

Accordingly, there is a need for a computer-implemented technique that improves the functioning of a server and related information processing apparatus by: (i) transforming high-level user setting information, including a theme, a work unit, and a period, into a structured prompt sentence and generation instruction data in a consistent and repeatable manner; (ii) integrating iterative regeneration based on user corrections into a managed server-side workflow; and (iii) computing and utilizing popularity indices and user emotional states at the system level to control the behavior of the generative AI model. By addressing these aspects as a computer technology problem, the invention aims to reduce user burden, improve the quality and relevance of generated works, and enhance the efficiency and controllability of server-side processing when interacting with a generative AI model.

The specific processing by the specific processing unit 290 of the data processing device 12 in Example 1 is realized by the following means.

The present invention provides a server comprising a processor configured to receive setting information including at least a theme, a work unit, and a period as creation content from a terminal, store and normalize the setting information in a storage apparatus, determine a structure of a generation instruction based on the normalized setting information, generate a prompt sentence by embedding the theme, the work unit, and the period into the determined structure, and convert the prompt sentence into generation instruction data for a generative AI model, to transmit the generation instruction data including the prompt sentence to the generative AI model through a communication apparatus, to acquire work data generated by the generative AI model based on the prompt sentence, and to transmit the work data to the terminal so that the work data is displayed on a display apparatus of the terminal, to detect that the user has corrected at least one of the setting information and the prompt sentence via the terminal and, in response, to iteratively repeat processing of generating an updated prompt sentence and processing of causing the generative AI model to regenerate work data based on the corrected information, to calculate, for a plurality of items of work data generated by the generative AI model, a popularity index based on at least evaluation information and browsing information acquired from one or more terminals, to generate ranking information in which the plurality of items of work data are ranked based on the popularity index, and to transmit display data including work data having a high popularity index and creator information corresponding to the work data to the terminal so that the work data and the creator information are displayed on the display apparatus, and to acquire state information of the user from at least one of the terminal and a sensor apparatus, estimate an emotional state of the user based on the state information, and change at least one of content of the prompt sentence and generation conditions of the generation instruction data according to the emotional state and transmit the changed generation instruction data to the generative AI model. This enables the server to technically improve the process by which high-level user settings are transformed into effective generation instructions, to control iterative interactions with the generative AI model in a structured and resource-efficient manner, and to adapt the generation behavior based on computed popularity indices and user emotional states, thereby enhancing the overall performance and reliability of the computer-implemented content generation system.

The term “processor” refers to a hardware logic device or a combination of hardware logic devices configured to execute instructions, perform arithmetic and logical operations, and control data processing within the server or information processing apparatus.

The term “terminal” refers to an electronic apparatus including at least a display apparatus and an input apparatus, configured to transmit data to and receive data from the server via a communication apparatus, and to provide a user interface for inputting information and viewing output data.

The term “display apparatus” refers to a hardware output device, such as a screen or monitor, configured to visually present information, including work data and creator information, to a user.

The term “input apparatus” refers to a hardware input device, such as a keyboard, pointing device, or touch-sensitive panel, configured to allow a user to input data, including setting information and correction information, into the terminal.

The term “information processing apparatus” refers to a computing system including at least a processor, a storage apparatus, and a communication apparatus, configured to execute programs and process data in cooperation with the terminal.

The term “storage apparatus” refers to a hardware data storage component, such as a volatile or non-volatile memory device, configured to store setting information, prompt sentences, work data, ranking information, and other data used in the system.

The term “communication apparatus” refers to a hardware communication interface and associated circuitry configured to send and receive data over a communication network between the server, the terminal, and a generative AI model.

The term “setting information” refers to data representing creation content provided by a user, including at least a theme, a work unit, and a period, and optionally including additional parameters that specify constraints or preferences for generation of a work.

The term “theme” refers to information indicating a general subject, concept, or topic for a work to be generated, such as a narrative motif, visual style, or design concept.

The term “work unit” refers to information indicating a scope or granularity of a work to be generated, such as one piece of content, one component, one scene, or one design element.

The term “period” refers to information indicating a temporal constraint or target duration associated with creation or completion of a work, such as a time limit, a deadline, or a time range.

The term “creation content” refers to a combination of the theme, the work unit, the period, and related user-defined conditions that specify requirements for generating a work.

The term “generation instruction” refers to a logical structure used by the processor to define how setting information is to be transformed into instructions suitable for controlling a generative AI model.

The term “prompt sentence” refers to text data generated by the processor, in which the theme, the work unit, the period, and related instructions are embedded, and which is intended to be input to a generative AI model as a natural-language or structured-language instruction.

The term “generation instruction data” refers to data derived from at least the prompt sentence and optionally additional parameters, formatted in a manner suitable for transmission to and processing by a generative AI model.

The term “generative AI model” refers to a machine learning model configured to generate data, such as text, images, or other content, in response to input data including a prompt sentence or generation instruction data.

The term “work data” refers to data representing at least one generated work or candidate work produced by the generative AI model based on a prompt sentence or generation instruction data.

The term “correction input” refers to information indicating a modification of at least one of the setting information and the prompt sentence, input by the user through the terminal to refine or adjust generation conditions.

The term “evaluation information” refers to data representing explicit or implicit assessments of work data by one or more users, including, for example, rating values, selection actions, or feedback indicators.

The term “browsing information” refers to data representing user access behavior with respect to work data, including, for example, view counts, viewing durations, or interaction logs.

The term “popularity index” refers to a computed measure indicating the relative popularity or attention level of work data, derived from at least evaluation information and browsing information.

The term “ranking information” refers to data indicating an order or hierarchy among a plurality of items of work data based on the popularity index, and optionally including scores, ranks, or grouping information.

The term “creator information” refers to data identifying or characterizing an originator or contributor of work data, including, for example, a user identifier, a profile attribute, or an aggregated performance indicator.

The term “state information” refers to data representing at least one condition or behavior of the user, obtained from the terminal or a sensor apparatus, and including, for example, input operation information, line-of-sight information, or biological information.

The term “sensor apparatus” refers to a hardware device configured to measure or detect physical or physiological quantities related to the user, such as motion, gaze, heart rate, or other biological signals, and to output corresponding sensor data.

The term “emotional state” refers to an inferred psychological condition of the user, such as a level of engagement, stress, frustration, satisfaction, or motivation, estimated by the processor based on the state information.

The term “input operation information” refers to data representing how the user operates the input apparatus or the terminal interface, including, for example, key presses, touch patterns, pointer movements, or timing information.

The term “line-of-sight information” refers to data representing a direction or position of the user's gaze relative to the display apparatus, obtained via a sensor apparatus or equivalent mechanism.

The term “biological information” refers to data representing a biological or physiological parameter of the user, such as heart rate, skin conductance, facial expression parameters, or similar measures obtained by the sensor apparatus.

The term “popular creator” refers to a creator identified by the processor as having a popularity index satisfying a predetermined condition, based on aggregation of popularity indices for multiple items of work data associated with the creator.

In one embodiment, the system includes a server, one or more terminals, at least one sensor apparatus, and a communication network connecting these components. The server includes at least one processor, a storage apparatus such as a main memory and a non-volatile storage device, and a communication apparatus such as a network interface controller. The terminal includes a display apparatus, an input apparatus, a local processor, a local memory, and a communication interface configured to communicate with the server. The sensor apparatus includes one or more sensors, such as a camera, a motion sensor, or a physiological sensor, and a communication interface configured to provide sensor data to the server or the terminal.

The server executes an application program on an operating system running on general-purpose computing hardware, such as a multi-core CPU and optionally a graphics processing unit (GPU). The server uses a web server framework and an application framework to receive requests from the terminal, process setting information, construct a prompt sentence, and interact with a generative AI model. The server stores setting information, prompt sentences, work data, ranking information, and popularity indices in the storage apparatus, which may be implemented by a relational database management system or a key-value store.

The terminal executes a client program implemented as a web browser application or a native application. The terminal controls the display apparatus to render input fields for a theme, a work unit, and a period, and controls the input apparatus to capture user operations such as key entries, touch gestures, and pointer movements. The terminal generates and transmits structured setting information to the server over a secure communication protocol, and receives and displays work data and ranking information from the server.

The user operates the terminal to input creation content. The user typically inputs a theme representing a general concept, such as “future city,” a work unit such as “one building,” and a period such as “one week.” The terminal stores this information in a local data structure and transmits it to the server. The server receives the setting information and stores it in the storage apparatus as records including at least a user identifier, a theme field, a work unit field, a period field, and timestamps.

The server processes the received setting information using a set of normalization and interpretation routines executed by the processor. The server applies text normalization such as lowercasing, whitespace trimming, punctuation standardization, and synonym mapping. The server interprets the period field by converting natural-language expressions into an internal temporal representation using a date-time library, so that a machine-readable constraint such as a start time and an end time is stored in association with the setting information. The server classifies the work unit into categories such as “single asset,” “multi-part asset,” “scene,” or “narrative unit” using a rule-based classifier implemented as a decision table or a small statistical model, and stores a task type code in the storage apparatus.

The server maintains a library of prompt templates in the storage apparatus. Each prompt template is defined as a data structure including fixed text segments and placeholder fields for theme, work unit, period, and optional parameters such as desired level of detail or style. The server selects a prompt template based on the task type and optionally the theme category. The server replaces placeholders in the template with normalized values of the theme, the work unit, and the period to generate a prompt sentence. For example, the server generates a prompt sentence such as:

“Based on the theme ‘future city,’ the user wants to design one building that could realistically be designed and roughly completed within one week. Please propose at least five creative building concepts. For each concept, describe the purpose of the building, the exterior style, the interior layout, key technologies used, and explain how the one-week period affects the level of detail and construction approach.”

The server stores the generated prompt sentence in association with the corresponding setting information. The server then converts the prompt sentence into generation instruction data suitable for a generative AI model. The server constructs a structured data object that includes the prompt sentence, a model identifier, and generation parameters such as maximum token count, sampling temperature, and top-p probability threshold. The server uses the communication apparatus to transmit the generation instruction data to a generative AI model hosted either on the same server, on a dedicated inference server, or on a remote computing environment accessible through an application programming interface.

The generative AI model is implemented as a parameterized neural network, such as a transformer-based large language model trained on a corpus of textual data. The model includes an embedding layer mapping input tokens to continuous vectors, a plurality of transformer blocks including multi-head self-attention layers and feed-forward layers, and an output layer producing probability distributions over a token vocabulary. The model has been trained using a supervised or self-supervised learning objective, such as minimizing a cross-entropy loss between predicted tokens and ground-truth tokens, with parameters updated by a gradient-based algorithm such as stochastic gradient descent or an adaptive variant. During training, the model uses techniques such as mini-batch optimization, learning rate scheduling, and regularization. The training phase may also employ data augmentation or curriculum learning to improve robustness and generalization.

During inference, the server or an inference backend converts the prompt sentence into a sequence of tokens using a tokenizer. The generative AI model processes the tokens through its layers, computing attention scores and hidden states for each layer. The model generates output tokens by iteratively sampling from the probability distribution at each step, according to decoding algorithms such as greedy decoding, top-k sampling, or nucleus sampling. The server receives from the inference backend generated work data as text sequences, which represent creative ideas, designs, or narratives.

The server performs post-processing on the generated work data. The server removes extraneous tokens or markup, segments the generated text into a structured list of ideas or components by detecting numbering patterns or headings, and converts the segments into a structured representation stored in the storage apparatus. The server associates work data with the corresponding user, prompt sentence, and setting information. The server then transmits the processed work data to the terminal through the communication apparatus.

The terminal receives the work data and updates the display apparatus to present the generated content. The terminal may display the prompt sentence for transparency and present each idea or design as a separate selectable element. The user views the work data and evaluates whether it satisfies the intended creative objective. The user may input a correction to the theme, the work unit, the period, or terms of the prompt sentence through the input apparatus. The terminal transmits the correction information to the server.

The server receives the correction information and updates the stored setting information or the stored prompt sentence. The server re-executes normalization and template filling, generates an updated prompt sentence reflecting the correction, and creates new generation instruction data. The server then causes the generative AI model to generate new work data. This iterative process enables the system to refine the creative output based on user feedback, while maintaining a structured and machine-controlled transformation from high-level settings to model input. Because the server manages the iteration and the template-based mapping, the system reduces the need for the user to manually craft complex prompt sentences, and thereby reduces user dependency and improves reproducibility.

The server further calculates a popularity index for multiple items of work data. The terminal acquires evaluation information, such as explicit ratings or preference selections, and browsing information, such as view counts and viewing durations, when the user views work data. The terminal transmits such information to the server. The server stores evaluation events and browsing logs in a structured format, including fields for user identifier, work data identifier, timestamp, and action type. The server periodically or on demand aggregates these logs and computes a popularity index for each item of work data using a predefined formula. For example, the server combines normalized rating scores, logarithmically scaled view counts, and recency-based decay functions to compute a scalar popularity value. The server then ranks items of work data by their popularity index and generates ranking information. The server stores the ranking information and uses it to identify work data with high popularity indices, as well as creators whose associated work data collectively exhibit high popularity indices. The server groups work data by creator and computes an aggregate popularity index for each creator. The server then identifies a set of popular creators according to predetermined thresholds or percentile criteria. The server prepares display data including the ranked work data, the popularity indices, and creator information, and transmits this display data to the terminal. The terminal controls the display apparatus to present ranked lists of work data and indicators of popular creators.

The server also acquires state information related to the user from the terminal and the sensor apparatus. The terminal transmits input operation information such as typing speed, correction frequency, and interaction patterns. The sensor apparatus may transmit line-of-sight information indicating where on the display apparatus the user is looking, and biological information such as heart rate or skin conductance. The server processes this state information to estimate an emotional state of the user using algorithms such as supervised classification or rule-based mapping. For example, the server may use a trained classifier that takes as features the average time between keystrokes, the variance of scroll speed, the frequency of prompt modifications, gaze stability metrics, and heart rate variability, and outputs a discrete emotional state label such as “frustrated,” “engaged,” or “bored.” The server uses the estimated emotional state to adjust the content of the prompt sentence and the generation conditions of the generation instruction data. When the user appears frustrated, the server may modify the prompt sentence to request more concrete, step-by-step output from the generative AI model, or may reduce the complexity of the requested work. When the user appears highly engaged, the server may increase the requested detail level and allow longer outputs. The server also adjusts generation parameters such as sampling temperature and maximum token counts to tune the variability and length of the generated work data. By incorporating emotional state as a control signal, the system modifies the internal computational behavior of the generative AI model and the template selection logic in a non-conventional and data-driven manner, thereby improving alignment between generated content and user conditions.

The system improves computer technology in several technical aspects. The server performs a structured transformation of high-level setting information into machine-effective generation instruction data using prompt templates and normalization procedures. This transformation reduces the variability of raw user input, which in turn reduces the number of required interactions with the generative AI model to achieve acceptable results. The structured mapping allows the server to reuse and cache intermediate representations, such as normalized setting information and template selections, across multiple sessions, thereby reducing computational load and network traffic. The integration of popularity indices and emotional states into the generation control path allows the server to dynamically adjust prompts and generation parameters to avoid unproductive model calls and to converge faster toward satisfactory output.

The server employs specific data structures, such as records for setting information, prompt templates with placeholder definitions, work data entries with segment annotations, log entries for evaluations and browsing events, and user-state feature vectors. The processor executes algorithms that parse, normalize, and map these data structures through deterministic and statistical transformations. This arrangement improves the organization and retrieval of data in the storage apparatus, enabling faster queries for ranking and retrieval of relevant work data. In addition, the server may store compressed representations of frequently used prompt sentences and hashed indices for quick matching of similar setting information, which further improves processing speed and scalability.

The generative AI model operates under server-controlled parameters and prompt structures that are not directly exposed to the user. The server decouples user input from low-level model input by enforcing non-conventional templates and generation parameter policies. For instance, the server may enforce that any prompt sentence for a design-related task contains explicit constraints about functional aspects and time-based limitations, and that any prompt sentence for a narrative task contains explicit instructions about plot structure. This rule-based and learned control layer constitutes a technical arrangement that changes how the underlying model resources are used, leading to more efficient computation and more predictable output behavior.

The system is not limited to textual work data. In another embodiment, the generative AI model is configured to generate imagery or multi-modal outputs. The server in such an embodiment still generates a text-based prompt sentence, for example:
“Please propose ten creative concept ideas for a single building in a futuristic city that should be designed and roughly completed within one week. For each idea, describe the building's purpose, exterior appearance, interior layout, and how it fits into the overall future city environment.”

The server then includes additional parameters in the generation instruction data specifying desired image resolution, aspect ratio, or layout. The generative AI model processes this prompt sentence and parameters to generate image representations. The server receives image data, performs post-processing such as resizing or format conversion, and transmits the images to the terminal for display. The structured control of prompt content and parameter selection similarly leads to reduced trial-and-error and more efficient use of computational resources in image generation.

In a further embodiment, the server supports multiple generative AI models with different capabilities or architectures. The server selects a model according to task type, complexity, or current system load. For example, the server may route simple tasks to a smaller model and complex tasks to a larger model, based on thresholds derived from the work unit and period fields. The server maintains performance statistics for each model and uses these statistics to adjust routing strategies over time, further improving processing efficiency and response time.

The terminal and the server cooperate to reduce communication load by employing incremental updates. The terminal transmits only changed portions of setting information or prompt sentences to the server. The server maintains versioned records and computes differences between versions to avoid redundant re-processing when only minor changes occur. This arrangement reduces bandwidth usage and combined processing time, especially when many users concurrently interact with the system.

Through these embodiments, the server, the terminal, and the generative AI model collectively implement a technical system that transforms user-level creation settings into structured, optimized model inputs, manages iterative refinement under server control, and leverages computed popularity indices and emotional states to adapt the computational behavior of the system. This configuration improves processing speed, output quality, data management, and resource utilization compared to systems in which users directly issue ad-hoc prompts to a generative AI model without server-controlled structuring and adaptive control.

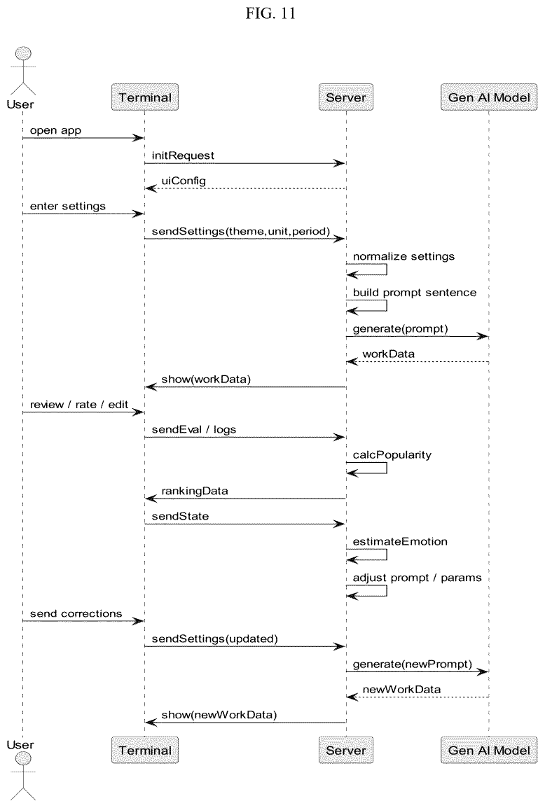

The following describes the processing flow using FIG. 11.

### Step 1:

The user operates the terminal to launch a client application and access the system.

The terminal sends an initial request to the server and receives configuration data defining input fields for a theme, a work unit, and a period.

The terminal takes as input no user data yet and outputs a rendered user interface on the display apparatus based on the configuration data.

### Step 2:

The user uses the input apparatus of the terminal to enter setting information including the theme, the work unit, and the period as text strings.

The terminal takes as input the raw keystrokes, touch events, or pointer events and converts them into structured setting information stored in local memory, including fields for theme, work unit, and period.

The terminal performs local validation on this setting information (for example, checking for non-empty fields and acceptable length) and outputs either an error message on the display or a validated setting object ready to be transmitted to the server.

### Step 3:

The terminal packages the validated setting information into a structured request message.

The terminal takes as input the validated setting object and encodes it into a message including a user identifier, a session identifier, and the setting fields.

The terminal performs data serialization and encryption for secure transmission, and outputs a network request sent via the communication interface to the server.

### Step 4:

The server receives the request message containing the setting information from the terminal.

The server takes as input the serialized message, performs decryption and deserialization, and stores the extracted theme, work unit, and period in records within the storage apparatus, together with metadata such as timestamps and user identifiers.

The server outputs a normalized representation of the setting information in working memory, which is used in subsequent processing.

### Step 5:

The server normalizes and interprets the received setting information.

The server takes as input the raw theme, work unit, and period strings and applies text preprocessing, including trimming whitespace, converting to a canonical case, and mapping synonyms to standardized terms.

The server converts the period into an internal temporal representation using a date-time library and classifies the work unit into a task type (for example, “single asset” or “short narrative”) using rule-based or statistical analysis, and outputs a structured internal object containing canonical theme text, task type codes, and start/end time fields.

### Step 6:

The server selects a prompt template based on the interpreted setting information.

The server takes as input the canonical theme text and the task type code and queries the storage apparatus for a corresponding prompt template that includes placeholder fields for theme, work unit, and period.

The server outputs a selected prompt template object that defines the structure and fixed parts of the prompt sentence.

### Step 7:

The server generates a concrete prompt sentence by filling the prompt template.

The server takes as input the selected template object and the canonical setting information, and replaces the placeholder fields with the specific theme, work unit, and period values.

The server performs string concatenation and formatting to produce a coherent natural-language instruction, for example:
“The user wants to design one building in a future city that can be completed in about one week. Please propose at least five detailed design ideas, including the building's purpose, exterior appearance, interior layout, and functional concepts, while keeping the one-week completion period in mind.”

The server outputs the generated prompt sentence as a text string and stores it in association with the user and the setting information.

### Step 8:

The server constructs generation instruction data for the generative AI model.

The server takes as input the prompt sentence and system parameters such as maximum token length, temperature, and top-p, and assembles them into a structured data object suitable for the generative AI model's application programming interface.

The server performs parameter encoding and attaches a model identifier, and outputs the generation instruction data ready for transmission to the generative AI model.

### Step 9:

The server transmits the generation instruction data to the generative AI model and triggers inference.

The server takes as input the generation instruction data and sends it via the communication apparatus to an inference backend hosting the generative AI model.

The generative AI model receives the prompt sentence, tokenizes it, processes it through internal layers, and generates output tokens representing work data.

The server outputs a received response containing generated work data in the form of one or more text sequences.

### Step 10:

The server post-processes the generated work data.

The server takes as input the raw generated text returned by the generative AI model and removes control tokens, extraneous markers, or repeated segments.

The server analyzes the text to detect structured elements such as numbered lists or headings, segments the text into separate ideas or components, and converts them into a structured internal format, such as an array of idea objects.

The server stores the structured work data in the storage apparatus associated with the originating user and the prompt sentence and outputs a clean, display-ready work data object.

### Step 11:

The server prepares a response for the terminal including the work data and associated information.

The server takes as input the structured work data, the original setting information, and the prompt sentence, and composes a response object that includes these elements and optional metadata such as timestamps and identifiers.

The server serializes and encrypts this response and outputs a network message sent via the communication apparatus to the terminal.

### Step 12:

The terminal receives the response and updates the user interface.

The terminal takes as input the serialized response message, performs decryption and deserialization, and extracts the work data, the prompt sentence, and the setting information.

The terminal formats the work data into visual components such as numbered lists, headings, and paragraphs, and outputs updated screen content displayed on the display apparatus so that the user can view the generated results.

### Step 13:

The user reviews the generated work data and evaluates its suitability.

The user takes as input the rendered ideas or designs displayed on the terminal and mentally compares them to the intended theme, work unit, and period.

The user visually inspects the details and may identify missing aspects or desired changes, and outputs an implicit evaluation that will be reflected in subsequent inputs, such as corrections or ratings.

### Step 14:

The user optionally provides evaluation information and browsing behavior data.

The user interacts with the terminal by performing operations such as rating the work, selecting favorite items, or spending time reading particular ideas.

The terminal takes as input these interaction events (for example, button clicks, scroll events, or dwell times on a specific item) and converts them into evaluation records and browsing logs.

The terminal outputs these records as structured data messages to the server.

### Step 15:

The server records and aggregates evaluation and browsing information.

The server takes as input the evaluation records and browsing logs from one or more terminals and writes them into log tables in the storage apparatus, associating each event with a work data identifier and a user identifier.

The server periodically reads the accumulated logs, applies aggregation functions such as counting views, averaging ratings, and calculating recency-weighted scores, and outputs intermediate statistics used for popularity analysis.

### Step 16:

The server calculates a popularity index and generates ranking information.

The server takes as input the aggregated statistics and applies a predetermined formula that may combine normalized ratings, logarithmic view counts, and time-based decay factors.

The server performs numerical computations to obtain a scalar popularity index for each item of work data and sorts items based on these indices to determine their relative ranks.

The server outputs ranking information that includes, for each item, a rank position, a popularity index value, and references to the corresponding work data and creator.

### Step 17:

The server identifies popular creators and prepares popularity-based display data.

The server takes as input the ranking information and groups work data by creator identifier to compute an aggregate popularity index for each creator.

The server applies thresholds or percentile criteria to select creators whose aggregate indices exceed a predetermined level and designates them as popular creators.

The server composes display data including lists of highly ranked work data and identifiers of popular creators, and outputs this display data for transmission to the terminal.

### Step 18:

The terminal receives popularity-based display data and renders ranking views.

The terminal takes as input the display data containing ranking information and popular creator information from the server and parses it into internal data structures.

The terminal updates the display apparatus to render ranked lists of work data, each with its popularity index, and to highlight or list popular creators, and outputs an updated user interface that allows the user to browse popular content.

### Step 19:

The terminal and the sensor apparatus provide state information about the user to the server.

The terminal takes as input low-level interaction data, such as keystroke timing, scrolling speed, and frequency of prompt changes, and summarizes these as input operation information.

The sensor apparatus takes as input physical signals such as gaze direction, motion, or physiological signals and converts them into digital sensor data.

The terminal and the sensor apparatus output state information messages transmitted via the communication interfaces to the server.

### Step 20:

The server estimates an emotional state of the user based on state information.

The server takes as input the input operation information, line-of-sight information, and biological information, and computes descriptive features such as average inter-keystroke intervals, standard deviation of scroll speed, gaze fixation duration on specific regions, and heart rate variability.

The server applies a classification algorithm, such as a trained supervised model or a rule-based classifier, to these features to assign an emotional state label (for example, “frustrated,” “neutral,” or “engaged”).

The server outputs an estimated emotional state associated with the current session or user.

### Step 21:

The server adjusts the prompt sentence and generation conditions based on the emotional state.

The server takes as input the estimated emotional state, the current setting information, and the previously generated prompt sentence.

The server modifies the prompt sentence by adding or changing instructions, such as increasing the level of explanation, reducing the complexity of requested content, or requesting more alternatives, and may adjust generation parameters such as temperature and maximum tokens.

The server outputs an updated prompt sentence and an updated set of generation instruction parameters ready to be used in a new generation instruction data object.

### Step 22:

The server initiates another generation cycle with corrected or adjusted information.

The user may correct the theme, work unit, period, or other content through the terminal, and the terminal sends the corrected information to the server.

The server takes as input the corrected information and, together with any modifications based on emotional state, regenerates a prompt sentence and constructs new generation instruction data.

The server then repeats the transmission to the generative AI model, the acquisition of new work data, and the post-processing and display preparation, and outputs updated work data that should better match both the user's objectives and current emotional state.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize generative artificial intelligence models largely rely on manual and ad hoc interactions between users and the models. A user typically inputs a free-form prompt sentence, receives a text or image output, and then manually iterates by revising the prompt sentence. Such systems suffer from several technical drawbacks in terms of computer technology.

First, the data flow from user input to final multimedia output is fragmented and unstructured. The generative artificial intelligence model may output narrative text, but there is no standardized, machine-readable transformation step that converts the narrative into structured script information including scene items, character items, and imaging items that can be directly consumed by image-generation software. As a result, additional manual intervention or bespoke scripting is required, which increases processing latency, wastes computing resources, and prevents the system from efficiently using automated rendering pipelines. Second, existing systems are not designed to coordinate end-to-end processing: from prompt sentence generation based on multiple user-defined parameters, through structured script generation and three-dimensional scene generation, to encoding and distribution of viewing-format image data. The lack of an integrated control unit for these stages leads to inefficient use of processors, graphics processing resources, and network bandwidth. For example, content may be repeatedly rendered or transcoded due to inconsistent intermediate formats, and servers cannot effectively manage reference information to distribution image data across multiple projects and users.

Third, collaborative editing involving multiple users is not natively supported at the level of system architecture. While multiple users may conceptually cooperate, current systems do not maintain a consistent state of prompt sentences, structured script information, and image data across different editing sessions. There is no mechanism for the processor to accept instructions from an initial user and a participating user in a coordinated manner, update at least one of the prompt sentence and the structured script information, and manage completion of the work as a unified, collaboratively edited artifact. This results in version divergence, redundant computation, and difficulties in synchronizing the generative artificial intelligence model with updated instructions.

Fourth, existing ranking and recommendation mechanisms are often loosely attached to content platforms and do not exploit fine-grained distribution image data metrics within the same processing pipeline. Viewing-count information and evaluation information may be collected, but they are not tightly integrated with the generation and distribution control logic to compute index values and generate ranking information for works or creators. This separation limits the system's capability to dynamically allocate computing and network resources to more popular works and to present optimized lists of distribution image data or creator information.

Fifth, systems that attempt to personalize content based on user emotions frequently treat emotion estimation and prompt generation as independent modules. Emotional signals derived from biological information or behavior information are not effectively coupled with the generation of prompt sentences and structured script information. As a result, the generative artificial intelligence model is not provided with instruction content that is adaptively modified in accordance with the user's emotional state, which diminishes the responsiveness and efficiency of the overall content generation process.

Accordingly, there is a need for an improved computer-implemented system that integrates (i) automated generation of a prompt sentence from structured user input parameters, (ii) transformation of generative artificial intelligence model output into structured script information, (iii) automatic control of image-generation software for three-dimensional scene generation and image data creation, (iv) conversion, storage, and reference management of distribution image data, (v) ranking computation based on viewing-count information and evaluation information, (vi) collaborative editing by multiple users at the prompt and script levels, and (vii) emotion-aware modification of instruction content. Such a system should improve the efficiency, scalability, and consistency of the underlying computer resources, reduce manual intervention, and provide a technically enhanced pipeline from user input to distribution image data delivery.

The specific processing by the specific processing unit 290 of the data processing device 12 in Application Example 1 is realized by the following means.

The present invention provides a server comprising a processor configured to receive theme information, work-unit information, and period information from a user terminal, generate a prompt sentence for content generation based on the theme information, the work-unit information, and the period information, and input the prompt sentence into a generative artificial intelligence model; obtain story information output from the generative artificial intelligence model, analyze the story information, and convert the story information into structured script information including a plurality of scene items, character items, and imaging items; control image-generation software based on the structured script information to set three-dimensional scene information and time information and automatically generate image data; convert the image data into viewing-format image data, store the viewing-format image data as distribution image data that is transmittable to the user terminal via a network, and manage reference information to the distribution image data; calculate an index value for each work based on viewing-count information and evaluation information for the distribution image data and generate ranking information for works or creators based on the index value; accept an input instruction of the prompt sentence by an initial user and an additional prompt input to the generative artificial intelligence model by a participating user, accept a correction instruction for at least one of the image data and the structured script information, and update at least one of the prompt sentence and the structured script information while causing a work to be completed by collaborative editing; and estimate an emotional state of a user based on at least one of biological information and behavior information acquired from the user terminal, modify instruction content included in at least one of the prompt sentence and the structured script information in accordance with the emotional state, and transmit the modified instruction content to the generative artificial intelligence model. This enables an integrated and computer-implemented processing pipeline that automatically transforms structured user input into optimized prompt sentences, converts generative artificial intelligence model output into machine-readable script structures, drives three-dimensional scene generation and image encoding under unified processor control, provides coordinated storage and reference management for distribution image data, dynamically computes and utilizes ranking information, supports synchronized collaborative editing across multiple users, and adaptively personalizes generation parameters based on estimated user emotions, thereby improving the technical performance, resource efficiency, and responsiveness of content generation and distribution systems.

The term “user terminal” refers to an information processing device operated by a user, such as a general-purpose computing device, mobile communication device, or display device, that is configured to transmit input information to a server and receive distribution image data via a communication network.

The term “theme information” refers to information indicating a concept, subject, or topic for content generation, which is input by a user and used by a processor as a basis for constructing a prompt sentence for a generative artificial intelligence model.

The term “work-unit information” refers to information indicating a unit, scale, or format of a work to be generated, such as a duration, episode length, or content type, which is used by a processor to control the structure and extent of generated content.

The term “period information” refers to information indicating a target period or time constraint for completion of content generation, which is used by a processor to adjust parameters of a prompt sentence or processing pipeline.

The term “prompt sentence” refers to a natural-language instruction string generated or modified by a processor and provided to a generative artificial intelligence model to cause the model to generate story information or other content corresponding to user-specified requirements.

The term “generative artificial intelligence model” refers to a machine learning model, such as a neural network-based language model, that is configured to generate content including text, story information, or other data in response to input prompt sentences.

The term “story information” refers to text data or structured data representing a narrative, scenario, or sequence of events output from a generative artificial intelligence model in response to a prompt sentence.

The term “structured script information” refers to information obtained by analyzing story information and organizing the story information into a machine-readable structure including a plurality of scene items, character items, and imaging items suitable for controlling image-generation software.

The term “scene item” refers to an element within structured script information that describes at least one of a location, time, situation, or sequence of actions forming a discrete scene in a work.

The term “character item” refers to an element within structured script information that describes attributes, roles, or behaviors of one or more characters that appear in at least one scene item.

The term “imaging item” refers to an element within structured script information that describes camera-related information, such as camera position, angle, movement, framing, or other imaging conditions used to generate image data.

The term “image-generation software” refers to a software application or software module, such as three-dimensional computer graphics software or animation software, that is configured to generate image data or moving-image data based on structured script information and scene configuration instructions.

The term “three-dimensional scene information” refers to data defining spatial structures, object arrangements, camera placements, lighting conditions, and other three-dimensional attributes in a virtual environment used to generate image data.

The term “time information” refers to data indicating temporal attributes of content, including timing, sequence order, frame positions, or duration associated with scenes or actions in a generated work.

The term “image data” refers to digital data representing one or more images or frames, including still images or moving images, generated by image-generation software under control of a processor.

The term “viewing-format image data” refers to image data that has been encoded or converted into a format appropriate for playback on a user terminal, such as a compressed video stream, container file, or streaming segment format.

The term “distribution image data” refers to viewing-format image data that is stored in association with reference information and is configured to be transmitted from a server to a user terminal via a network.

The term “reference information” refers to information such as identifiers, addresses, file paths, or URLs that enable a processor or user terminal to identify, access, or retrieve corresponding distribution image data.

The term “viewing-count information” refers to information indicating the number of times distribution image data has been accessed, played, or viewed by one or more user terminals.

The term “evaluation information” refers to information indicating user feedback related to distribution image data, including ratings, scores, reactions, or other evaluation metrics provided via user terminals.

The term “index value” refers to a numerical or categorical value calculated by a processor for each work, based on at least viewing-count information and evaluation information, and used as a basis for ranking works or creators.

The term “ranking information” refers to information indicating an order or relative position of works or creators, generated by sorting index values associated with the works or creators.

The term “initial user” refers to a user who first issues an input instruction of a prompt sentence or initiates a content generation project within a system.

The term “participating user” refers to a user who participates after the initial user and provides additional prompt inputs, correction instructions, or edits to structured script information or image data in cooperation with the initial user.

The term “correction instruction” refers to an instruction input by an initial user or a participating user to modify at least one of a prompt sentence, structured script information, or image data in order to adjust or refine generated content.

The term “collaborative editing” refers to a process in which an initial user and at least one participating user cooperatively provide instructions, edits, or modifications to prompt sentences, structured script information, or image data, while a processor maintains a consistent work state and updates content generation accordingly.

The term “creator information” refers to information associated with a creator of a work, including at least a creator identifier, profile information, or linkage to one or more works generated within a system.

The term “biological information” refers to information related to physiological states of a user, such as heart rate, skin conductance, facial expression data, or other biometric signals, that can be acquired via sensors of a user terminal or associated devices.

The term “behavior information” refers to information related to actions, interactions, or operation patterns of a user, such as input sequences, gaze direction, motion data, or viewing behavior, acquired via a user terminal.

The term “emotional state” refers to a state representing a user's emotion or affective condition, such as excitement, calmness, interest, or boredom, estimated by a processor based on at least one of biological information and behavior information.

The term “instruction content” refers to content of control information, including conditions, constraints, or directives, contained in at least one of a prompt sentence and structured script information, and provided to a generative artificial intelligence model or image-generation software to influence generated output.

In one embodiment, a server executes a program that implements the claimed system by using a combination of general-purpose computing hardware and specialized software components. The server includes at least one central processing unit (CPU), at least one graphics processing unit (GPU), a main memory, a non-volatile storage device, and a network interface. The server runs an operating system such as a general-purpose server operating system, a web server process, an application server process, and a database management system. The server communicates with at least one terminal operated by a user over a packet-based communication network such as the Internet.

The server uses a web server and an application server to provide a user interface to the terminal. The terminal executes a browser or a dedicated application on user hardware such as a smartphone, tablet, head-mounted display, or personal computer. The user operates the terminal to input theme information, work-unit information, and period information. The terminal transmits these items as structured request data over an encrypted transport protocol to the server. The server parses the request data, stores the items in a relational database, and generates a prompt sentence in natural language.

The server uses dedicated data structures to manage the information. For example, the server maintains a project record that includes fields for theme information, work-unit information, period information, user identifiers, and status values. The server further maintains separate tables or collections for prompt sentences, story information, structured script information, image data, distribution image data, and ranking information. By separating these entities and managing them through explicit identifiers, the server improves data management and enables efficient indexing, caching, and retrieval operations, which reduces database query time and I/O overhead.

The server generates a prompt sentence by applying a template-based algorithm that operates on the stored theme information, work-unit information, and period information. The server loads a text template from storage and performs variable substitution. For example, the server can generate an English prompt sentence such as:
“Create a detailed story for a 5-minute animation based on the following theme: ‘a day in an eco-building in a future city’. The work should be completable in about 7 days. Describe the main characters, the internal and external environment of the building, and a sequence of scenes suitable for animation, including camera directions and dialogue.”

The server then uses an application programming interface to transmit this prompt sentence to a generative AI model located on a machine equipped with GPU hardware. In one embodiment, the generative AI model is a transformer-based neural network language model.

The model consists of multiple layers of self-attention blocks and feed-forward networks, each with trainable weight matrices, bias vectors, and layer-normalization parameters. The model has been trained in advance using a supervised or self-supervised learning procedure that minimizes a cross-entropy loss function between predicted tokens and ground-truth tokens, with stochastic gradient descent or a variant such as Adam used to update the weights.

The server configures the generative AI model with explicit parameters, such as maximum output length, temperature, and top-k or top-p sampling thresholds. The generative AI model receives the prompt sentence as a token sequence, encodes each token into an embedding vector, and applies multi-head attention operations. The model performs matrix multiplications and non-linear activations across the layers. The model outputs a probability distribution over the next token at each step and iteratively generates story information. This internal processing uses GPU-accelerated linear algebra libraries and batched computation. The server receives the completed story information as text data.

The server then analyzes the story information to create structured script information. The server can execute a dedicated natural language processing module that uses rule-based parsing, pattern matching, and optionally a secondary generative AI model configured for information extraction. The server identifies scene boundaries, character names, actions, and camera-related descriptions. For example, the server can generate another prompt sentence as:
“Convert the following story into a scene-by-scene script. For each scene, output ‘Scene Title’, ‘Location’, ‘Time of Day’, ‘Characters’, ‘Actions’, and ‘Camera Directions’ in a structured format: [story text here].”

The server submits this prompt sentence to the generative AI model and receives a structured representation. The server parses this structured output into a machine-readable form such as a hierarchical object. The server assigns each scene item a unique identifier and associates character items and imaging items with that scene item. The server stores the resulting structured script information in the database. Because the server converts unstructured story information into a normalized script structure, the server enables deterministic linkage between narrative elements and specific rendering parameters, thereby reducing ambiguity and manual scripting requirements.

The server uses the structured script information to control image-generation software installed on a rendering node. In one embodiment, the server uses three-dimensional computer graphics software capable of scripting through a language such as a general-purpose scripting language interface. The server generates commands that instruct the image-generation software to create virtual cameras, lighting objects, character models, and environmental assets. The server configures three-dimensional scene information by mapping scene item attributes to camera coordinates, object positions, and light source parameters. The server configures time information by mapping scene durations and transitions to timeline positions, frame ranges, and animation keyframes.

The server transmits the structured script information, including camera trajectories and object animation parameters, to the image-generation software via a programmatic interface. The image-generation software executes a non-interactive rendering process using CPU and GPU resources. The rendering process computes geometric transformations, visibility relationships, shading, and rasterization. The software writes image data to storage as frame sequences or as intermediate video streams. By algorithmically controlling scene set-up and rendering, the server eliminates many manual steps in conventional animation pipelines and improves the consistency of camera behavior, motion continuity, and scene composition across different works.

The server converts the raw image data into viewing-format image data by using dedicated encoding software such as a command-line video encoder. The server selects codec parameters such as frame rate, resolution, bit rate, group-of-pictures length, and chroma subsampling in accordance with target terminals and network conditions. The server generates one or more output variants, such as a high-resolution stream and a low-resolution stream, by executing the encoder with different parameter sets. The server stores the viewing-format image data in a non-volatile storage system or an object storage service and registers the corresponding file locations and uniform resource locators (URLs) as reference information in the database.

The server manages distribution image data by maintaining metadata records that associate each encoded file with the corresponding project, user, and version. The server uses these metadata records to generate playlists or manifests for streaming protocols. The server also uses cache-control headers and content distribution networks to reduce network latency and decrease the load on the origin server. By controlling the encoding and distribution process at the server level with explicit metadata management, the system reduces redundant transcoding operations and improves throughput, which constitutes a technical improvement in the efficiency of multimedia processing.

The server monitors interactions from terminals to compute viewing-count information and evaluation information. When a terminal begins or completes playback of distribution image data, the terminal transmits event data including timestamps, playback position, and rating values to the server. The server aggregates these events in dedicated tables using batch or streaming analytics. The server calculates an index value for each work using a ranking function that may combine normalized viewing-count information, dwell time, and user ratings. For example, the server can compute a weighted sum of logarithmic view counts and average rating scores. The server then sorts works and creators by the index values to generate ranking information. Because the server uses a defined ranking algorithm and stores intermediate statistics, the server can update rankings incrementally and avoid recomputing aggregates from raw logs, which reduces computation cost.

The server displays, via the terminal, one or more lists based on the ranking information. The terminal requests ranking data, and the server returns data representing top-ranked works and creators. The terminal renders an interface that shows thumbnails, titles, and creator identifiers. By centralizing ranking computation in the server and exposing only compact result sets to terminals, the system reduces communication overhead and avoids redundant computation on user devices.

The server also supports collaborative editing by multiple users. The initial user and at least one participating user can access an editing interface on their respective terminals. The terminals present controls for modifying the prompt sentence and for adjusting elements of the structured script information. When a user edits the prompt sentence or a script field, the terminal transmits a change request including a version identifier to the server. The server applies concurrency control, such as optimistic locking or version merging, to maintain a consistent version of the script. The server may record a history of changes per user and per field. When the server receives an updated prompt sentence, the server may re-generate story information or adjust specific scenes by issuing incremental prompt sentences to the generative AI model. The server then updates the structured script information accordingly. This controlled, version-aware pipeline allows efficient re-rendering of only affected parts of the work and reduces unnecessary rendering, thereby improving processing speed and hardware utilization.

In another embodiment, the server estimates an emotional state of a user and uses this estimated state to modify instruction content in the prompt sentence or structured script information. The terminal collects biological information, such as heart rate and facial expression features, from sensors and cameras, and behavior information, such as cursor movement, scroll speed, or head movement in a head-mounted display. The terminal transmits these features periodically to the server. The server executes an emotion estimation model, which can be another neural network trained on labeled physiological and behavioral datasets. This model may use a multi-layer perceptron or recurrent layers and minimizes a loss function defined over discrete or continuous emotion labels.

The server receives a predicted emotional state, such as “high interest,” “low engagement,” or a level of excitement. The server applies a rule set or learned mapping that modifies certain parts of the prompt sentence or structured script information. For example, if the user's emotional state indicates decreasing engagement, the server may modify the prompt sentence to request more dynamic scenes or shorter scene durations. The server can generate a modified prompt sentence such as:
“Revise the story to increase pacing and include more high-tension scenes in the middle section, while maintaining the original theme of ‘a day in an eco-building in a future city’. Emphasize character conflicts and surprising environmental events.”

By dynamically modifying prompt sentences and script parameters based on emotion estimation, the server achieves an adaptive content generation strategy that cannot be practically replicated by manual human editing at real-time scale. The server applies these modifications through formalized data structures and algorithms, resulting in improved personalization and better use of computational resources, as only relevant parts of the script are adjusted.

The generative AI model used by the server can be trained using a corpus of narrative and script data. The training pipeline includes tokenization, vocabulary construction, batch formation, and forward and backward passes through the transformer layers. The model uses self-attention mechanisms to compute attention weights, and the training algorithm updates weights by computing gradients of the loss function and applying weight updates using learning rate schedules and regularization techniques. The server stores the trained model parameters in non-volatile memory on a GPU-enabled machine. During inference, the server configures generation parameters to control randomness and length, ensuring that output story information conforms more tightly to the structure required by downstream parsing. The system provides technical effects that extend beyond a mere automation of human tasks. The server improves processing speed by using structured representations and incremental re-generation strategies, which allow partial updates instead of full re-generation and re-rendering. The server improves accuracy and consistency by converting unstructured narrative text into explicit, machine-readable script structures that directly drive three-dimensional scene configuration. The server improves data management by using normalized tables, explicit identifiers, and metadata-based reference information for distribution image data. The server improves computational efficiency by reducing redundant rendering and transcoding operations and by optimizing encoding parameters for specific terminal classes.

The system further reduces network bandwidth usage by adapting stream resolutions and selectively transmitting only necessary data and ranking summaries.

In alternative embodiments, the server may use different generative AI models, such as encoder-decoder architectures or diffusion-based models, for text, image, or hybrid media generation. The server may deploy the image-generation functionality on separate rendering clusters or cloud-based GPU instances. The server may encode distribution image data into different container formats or access protocols. The emotion estimation model may use different combinations of features and may incorporate time-series analysis to capture trends. In all embodiments, the server, the terminal, and the user cooperate through defined data structures, algorithms, and model configurations. The system couples natural language generation, script structuring, three-dimensional scene control, encoding, distribution, ranking, collaborative editing, and emotion-aware adaptation into a unified computational pipeline. This integration yields improved performance and technical reliability in the operation of computer-based content generation and distribution systems.

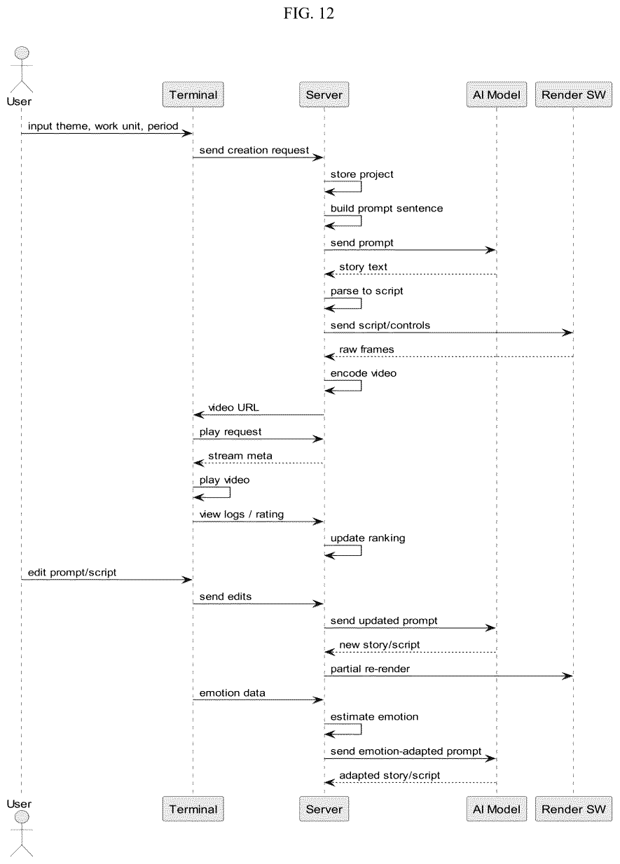

The following describes the processing flow using FIG. 12.

### Step 1:

User operates the terminal to access a content creation interface provided by the server.

User inputs theme information, work-unit information, and period information into input fields displayed on the terminal.

Terminal receives the user's keystrokes and selections as raw UI events, validates that required fields are not empty and that the period is within an allowable range, and then aggregates these values into a structured request message.

Input: User's theme text, selected work-unit type, and period value.

Terminal formats the input into structured data (for example, a set of key-value pairs), encodes it using a data interchange format, and transmits it to the server over a secure communication channel.

Output: A structured creation-request message delivered from the terminal to the server.

### Step 2:

Server receives the structured creation-request message via a network interface and passes it to an application server process.

Server parses the message to extract theme information, work-unit information, and period information, and performs server-side validation such as length checks, character-set checks, and range checks.

Input: Structured creation-request message containing theme information, work-unit information, and period information.

Server stores these values in a project record in a database by executing an insertion operation and generating a unique project identifier. The server also initializes status fields for the project.

Output: A persistent project record containing the user's input and an associated project identifier.

### Step 3:

Server retrieves the stored project record from the database by referencing the project identifier.

Server generates a prompt sentence by applying a template-based text generation algorithm that combines the theme information, work-unit information, and period information.

Input: Project record including theme, work-unit, and period fields.

Server loads a prompt template from storage, replaces placeholder tokens with the actual field values, and performs basic natural language adjustments such as pluralization or phrase insertion. The server then produces a complete prompt sentence, for example:
“Create a detailed story for a 5-minute animation based on the following theme: ‘a day in an eco-building in a future city’. The work should be completable in about 7 days. Describe the main characters, the internal and external environment of the building, and a sequence of scenes suitable for animation, including camera directions and dialogue.”

Output: A generated prompt sentence stored in association with the project identifier.

### Step 4:

Server prepares a request for a generative AI model by embedding the prompt sentence into a model-specific request structure.

Server sets generation parameters such as maximum length, temperature, and sampling strategy, and then transmits the request to the generative AI model over a model API endpoint.

Input: Prompt sentence and generation parameters.

Server causes the generative AI model to perform neural network inference, where the model tokenizes the prompt, computes hidden representations via multiple attention layers and feed-forward networks, and outputs a sequence of tokens representing story information. Server receives this story information as text, verifies integrity of the response, and logs model metadata.

Output: Story information text associated with the project identifier.

### Step 5:

Server analyzes the story information to derive structured script information suitable for controlling image-generation software.

Server applies a parsing module that identifies scene boundaries, character descriptions, and camera-related expressions using pattern matching, token classification, or a secondary generative AI model configured for information extraction.

Input: Story information text.

Server segments the text into scenes, assigns scene titles, extracts character names and roles, and detects phrases that describe camera positions, angles, and movements. The server encapsulates these elements into a structured representation comprising scene items, character items, and imaging items, each tagged with identifiers and attributes.

Output: Structured script information stored in a database in association with the project identifier.

### Step 6:

Server converts the structured script information into control instructions for image-generation software running on a rendering node.

Server maps each scene item to three-dimensional scene parameters, each character item to corresponding model or rig identifiers, and each imaging item to camera transforms and animation keyframes.

Input: Structured script information including scene items, character items, and imaging items.

Server generates control data structures such as scene graphs, camera tracks, and animation timelines, and writes configuration data or control commands that can be consumed by the image-generation software.

Output: Rendering control data ready for execution by the image-generation software.

### Step 7:

Server invokes the image-generation software in a non-interactive mode on the rendering node.

Server supplies the rendering control data to the software, which constructs virtual scenes, positions cameras, arranges lights, and places character models according to the received parameters.

Input: Rendering control data defining three-dimensional scene information and time information.

Server monitors the rendering process as the software performs geometric calculations, shader evaluations, and rasterization on CPU and GPU resources, and the software outputs raw image data as a sequence of frames or an intermediate video file.

Output: Raw image data representing the generated visual content for the project.

### Step 8:

Server converts the raw image data into viewing-format image data suitable for playback on terminals.

Server executes an encoding pipeline that reads the raw frames, applies compression algorithms, sets codec parameters, and multiplexes audio if present.

Input: Raw image data (for example, frame sequences or uncompressed video).

Server generates encoded video files in one or more formats and resolutions by performing temporal and spatial compression, quantization, and packaging into container formats, then stores these files as distribution image data in a storage subsystem and records reference information (such as file paths and URLs) in the database.

Output: Distribution image data and corresponding reference information associated with the project.

### Step 9:

Server receives playback or access requests from terminals for specific projects.

Terminal sends a request that includes the project identifier or a reference token, and the server resolves this identifier to the corresponding reference information for the distribution image data.

Input: Playback request including project identifier or reference token.

Server returns metadata such as streaming URLs, available resolutions, and duration, enabling the terminal to request the appropriate distribution image data streams from storage or a content delivery node.

Output: Playback metadata and access information for distribution image data.

### Step 10:

Terminal uses the received metadata to request and stream the distribution image data.

Terminal establishes media connections to the indicated URLs, downloads video segments or file data, and decodes the encoded video using local hardware decoders.

Input: Streaming URLs and distribution image data segments.

Terminal renders the decoded frames on a display or in a head-mounted display, synchronizing video (and audio if present) for user viewing, and transmits playback events, such as start, stop, and completion, back to the server as interaction logs.

Output: Visual playback to the user and interaction event records transmitted to the server.

### Step 11:

Server aggregates interaction event records to compute viewing-count information and evaluation information for each work.

Server performs data processing operations such as counting play events, summing view durations, and averaging rating values using database queries or analytics modules.

Input: Logged interaction events including playback actions and user ratings.

Server calculates an index value per work using a defined ranking function that combines normalized viewing-count information and evaluation information, and then sorts works or creators by these index values to generate ranking information.

Output: Ranking information for works and creators stored and available for retrieval.

### Step 12:

Server responds to ranking information requests from terminals.

Terminal sends a request to retrieve lists of popular works or creators, and the server queries the stored ranking information.

Input: Ranking retrieval request specifying list type or constraints.

Server generates a response payload containing ordered entries with summary data, such as work identifiers, titles, creator identifiers, and thumbnail references, and sends this payload to the terminal for display.

Output: Ordered ranking lists enabling the terminal to present ranked works or creators.

### Step 13:

User performs collaborative editing by modifying prompt sentences or script elements through an editing interface on the terminal.

Terminal captures editing operations, such as text changes or field adjustments, and attaches version information indicating the current revision state.

Input: User edits to the prompt sentence or elements of the structured script information.

Server receives the edits, checks version consistency, merges changes if needed, and updates the stored prompt sentence or structured script information. When certain thresholds are met, the server triggers partial regeneration of story information, script segments, or rendered segments, thus minimizing redundant processing.

Output: Updated prompt sentences and structured script information, and selectively updated image data for the collaboratively edited work.

### Step 14:

Server estimates a user's emotional state and adapts instruction content accordingly.

Terminal collects biological information and behavior information from sensors and interfaces, such as heart rate, facial movement patterns, input speed, or gaze direction, and sends feature data to the server.

Input: Feature data representing biological information and behavior information.

Server processes the feature data through an emotion estimation model to obtain an emotional state label or score, and then applies rules or mappings to adjust parts of the prompt sentence or structured script information (such as pacing, tone, or intensity parameters). The server generates updated instruction content and may issue modified prompt sentences like:
“Revise the story to increase pacing and include more high-tension scenes in the middle section, while maintaining the original theme of ‘a day in an eco-building in a future city’.

Emphasize character conflicts and surprising environmental events.”

Output: Emotion-adapted prompt sentences and script parameters that feed subsequent content generation and refinement.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content generation systems that utilize a generative AI model generally treat AI output as a one-time response to a single prompt sentence and do not provide a structured computational framework for multi-user, iterative collaboration. As a result, server-side components are often implemented as simple pass-through interfaces that forward a prompt sentence to a generative AI model and return the generated content to a single client. Such architectures lack mechanisms for managing creation sessions, associating multiple prompt sentences and versions of works, and aggregating user evaluations in a way that is efficiently processable by a computer system.

In particular, existing systems typically do not provide: (i) a session-level data structure on the server that consistently binds a selected abstract subject, a series of prompt sentences, and multiple generated versions of a work; (ii) server-side control logic for constructing contextual request data that combines an existing work and an additional prompt sentence for iterative extension by the generative AI model; and (iii) integrated computation for access control, popularity ranking, and creator statistics that operate over hierarchically related works and their feedback records. Consequently, known systems rely heavily on manual coordination and ad hoc data handling at the client side, which leads to redundant data transfer, inconsistent version management, and increased load on both clients and back-end databases.

Furthermore, conventional platforms that attempt to rank works or creators often calculate simple counts or scores without tightly integrating these metrics into the data model of works, sessions, and users. As a result, the server cannot efficiently compute or update popularity information and attention information across large numbers of works generated by a generative AI model. This impairs scalability, leads to performance bottlenecks in querying and updating rankings, and limits the ability of the system to provide real-time or near real-time feedback to users.

Additionally, existing systems typically lack a robust server-side mechanism for recording, at the level of computer-readable records, creator identifiers, generation time information, and content summaries for each work and its versions. Without such structured records, it is difficult for the server to automatically determine access authority and use conditions for each work, which in turn restricts fine-grained access control and reliable enforcement of usage policies. This leads to security risks, inconsistent access behavior, and an inability to provide verifiable history of collaborative editing operations.

There is therefore a need for a computer-implemented technique that improves the way a server manages and processes collaborative content generation with a generative AI model. Such a technique should reorganize the server's processing pipeline to: (i) create and maintain creation sessions that bind abstract subjects, prompt sentences, generated works, and version hierarchies; (ii) construct and transmit contextual request data for iterative generation by the generative AI model; (iii) compute and store popularity and ranking information together with creator statistics; and (iv) determine and enforce access authority and use conditions based on structured records. By improving the internal data structures and processing logic of the server in this manner, the overall efficiency, scalability, and reliability of computer-based collaborative content generation can be enhanced.

The specific processing by the specific processing unit 290 of the data processing device 12 in Example 2 is realized by the following means.

The present invention provides a server comprising a processor and a storage apparatus, wherein the processor is configured to control communication with a plurality of terminals, to manage creation sessions each associated with at least an abstract subject for creation and a plurality of prompt sentences, to convert prompt sentences into request data for a generative AI model, to store generated content as works in association with corresponding creation sessions and prompt sentences, to construct contextual request data including content of an existing work and an additional prompt sentence for iterative generation by the generative AI model, to record hierarchical relationships among an original version of a work and at least one of an extended version and a revised version thereof, to store and aggregate evaluation information and viewing counts for each work, to calculate popularity information and ranking information for the works on the basis of the aggregated data, to calculate and store creator statistics on the basis of the ranking information, and to create, for each work and version management information thereof, a record including at least a creator identifier, generation time information, and summary information of content data, and to determine, on the basis of the record, at least one of access authority and use condition of the work and control provision of the work in response to a request from a terminal. This enables the server to improve computer operation for collaborative content generation by centralizing session management, version-aware request construction, ranking computation, and access control enforcement, thereby reducing redundant processing on terminals, improving consistency and scalability of data handling on the server, and allowing efficient real-time or near real-time feedback and secure access management for works generated by the generative AI model.

The term “server” refers to an information processing apparatus including at least one processor and at least one storage apparatus, the information processing apparatus being configured to communicate with one or more terminals via a communication network and to execute programs for managing creation sessions, prompt sentences, works, and related data. The term “processor” refers to one or more hardware circuits for executing machine-readable instructions, such as a central processing unit or a graphics processing unit, configured to perform at least control, calculation, and data management operations in the server.

The term “storage apparatus” refers to one or more computer-readable media, such as a semiconductor memory, a magnetic storage device, or an optical storage device, configured to store at least program code, prompt sentences, works, session information, evaluation information, ranking information, and records related to access control.

The term “terminal” refers to an information processing device operated by a user, such as a portable communication device, a personal computer, or a tablet device, the information processing device including at least a display apparatus and a communication interface and being configured to send and receive data to and from the server.

The term “display apparatus” refers to a hardware component, such as a liquid crystal display or an organic electroluminescent display, configured to visually present information to a user at a terminal.

The term “communication network” refers to one or more wired or wireless communication infrastructures, such as a local area network or a wide area network, configured to transmit data between the server and one or more terminals.

The term “user” refers to a human operator who uses a terminal to interact with the server, including at least a first user who initiates a creation session and one or more participating users who contribute to works within the creation session.

The term “abstract subject” refers to conceptual information indicating a theme or topic for creation, the conceptual information not being limited to a specific instance and being used as a basis for generating prompt sentences and works.

The term “creation session” refers to a logical unit of processing managed by the server that associates at least a selected abstract subject, one or more prompt sentences, and one or more works generated in relation to the abstract subject.

The term “identification information for a creation session” refers to data, such as a session identifier, that uniquely distinguishes one creation session from other creation sessions within the server.

The term “prompt sentence” refers to text information input by a user and transmitted from a terminal to the server, the text information being included in request data to instruct a generative AI model to generate or modify content of a work.

The term “generative AI model” refers to a machine learning model configured to generate content, such as text, image data, or audio data, on the basis of input data including at least one prompt sentence, the machine learning model being executed by a computation resource external to the server or internal to the server.

The term “computation resource” refers to one or more hardware resources, such as processors and memories, configured to execute the generative AI model and to return generated content to the server.

The term “request data” refers to structured data generated by the processor and transmitted to the generative AI model, the structured data including at least one prompt sentence and optionally contextual information, model parameters, and control instructions.

The term “generated content” refers to content produced by the generative AI model in response to request data, the content including at least textual content and optionally other types of data.

The term “work” refers to data stored by the server as a result of processing generated content from the generative AI model, the data being associated with at least one prompt sentence and a creation session and representing a unit of creative output.

The term “display data of the work” refers to data generated by the processor to cause a terminal to present a work on a display apparatus, the data including at least textual content and layout information.

The term “participating user” refers to a user other than the first user who accesses a work associated with a creation session and who provides at least one of evaluation information, comment information, and an additional prompt sentence.

The term “evaluation information” refers to data input by a user indicating an assessment of a work, such as a rating value or selection of an evaluation level, and stored by the server in association with the work.

The term “comment information” refers to text data input by a user as feedback or opinion regarding a work, the text data being stored by the server in association with the work.

The term “additional prompt sentence” refers to a prompt sentence input by a user with respect to an existing work, the prompt sentence being used to request generation of an extended version or a revised version of the work by the generative AI model.

The term “contextual information” refers to information included in request data for the generative AI model, the information including at least part of the content of an existing work and optionally previous prompt sentences, used to provide context for iterative generation.

The term “extended version” refers to a work generated by the generative AI model on the basis of contextual information including an existing work and an additional prompt sentence, the generated work adding content to the existing work while maintaining a relationship with the existing work.

The term “revised version” refers to a work generated by the generative AI model on the basis of contextual information including an existing work and an additional prompt sentence, the generated work modifying or replacing at least a part of the existing work.

The term “hierarchical relationship” refers to an association recorded by the server between an original version of a work and at least one of an extended version and a revised version of the work, the association indicating a parent-child or ancestor-descendant linkage among versions.

The term “viewing count” refers to a numerical value representing how many times a work has been accessed or displayed at terminals, the numerical value being stored and updated by the server.

The term “popularity information” refers to information calculated by the processor on the basis of at least evaluation information and viewing counts for a work, the information indicating a degree of favorable reception for the work.

The term “attention information” refers to information calculated by the processor on the basis of at least evaluation information and viewing counts for a work, the information indicating a degree of attention or interest that the work has received.

The term “ranking information” refers to data representing an order or relative position among multiple works on the basis of at least one of popularity information and attention information.

The term “creator” refers to a user who is associated with generation of at least one work, such as a first user who inputs an initial prompt sentence or a participating user who contributes an additional prompt sentence that leads to generation of a version of the work.

The term “creator statistics” refers to aggregated information calculated by the processor for each creator on the basis of ranking information, evaluation information, viewing counts, or numbers of works, the aggregated information including at least one metric indicating performance or activity of the creator.

The term “highly rated creator” refers to a creator identified by the processor on the basis of at least one of ranking information and creator statistics as satisfying a predetermined condition related to performance or evaluation.

The term “record” refers to structured data stored by the server for a work and version management information thereof, the structured data including at least a creator identifier, generation time information, and summary information of content data.

The term “creator identifier” refers to data that uniquely identifies a creator within the system, such as a user ID or account ID stored by the server.

The term “generation time information” refers to data indicating a time or date at which a work or a version of the work was generated or registered by the server.

The term “summary information of content data” refers to compact data derived from the content of a work, such as a hash value, a short text summary, or feature data, used for identification, integrity checking, or classification.

The term “access authority” refers to a condition or permission level determined by the processor that specifies whether a terminal associated with a particular user is allowed to obtain or display data of a work.

The term “use condition” refers to a rule determined by the processor that specifies how a work may be used, such as whether sharing, copying, or modification is allowed and under what constraints.

The term “work acquisition request” refers to a request transmitted from a terminal to the server, the request including information identifying a target work and asking the server to provide data of the work.

The term “emotional state information” refers to information obtained from a terminal that indicates a psychological or affective state of a user, the information being used by the processor to generate auxiliary information or a modification instruction for a prompt sentence.

The term “auxiliary information” refers to supplemental information generated by the processor on the basis of emotional state information, the supplemental information being used to complement or guide a prompt sentence transmitted to the generative AI model.

The term “modification instruction” refers to information generated by the processor on the basis of emotional state information, the information specifying how to modify or adjust a prompt sentence before it is included in request data for the generative AI model.

In one embodiment, a server implements the claimed system using general-purpose computing hardware and well-defined software modules. The server uses at least one multi-core central processing unit (CPU), such as an x86-based processor, optional graphics processing units (GPUs) for neural network inference, a main memory, and non-volatile storage such as a solid-state drive. The server executes an operating system, such as a UNIX-compatible operating system, and application software that includes a web server framework, an application logic layer, a database management system, and a client for accessing a generative AI model. The server communicates with a plurality of terminals via a packet-switched communication network, such as the Internet, using standardized communication protocols.

A terminal is implemented as a personal computer, a tablet device, or a portable communication device. The terminal comprises at least a CPU, a display apparatus such as a liquid crystal display, an input apparatus such as a touch panel or keyboard, and a network interface. The terminal executes a web browser or a native application to provide a graphical user interface. A user operates the terminal to interact with the server.

The server uses a database management system, such as a relational database system, to store structured data for creation sessions, prompt sentences, works, evaluation information, ranking information, and records related to access control. The server defines explicit tables and indices for efficient retrieval. For example, the server defines a session table that stores, for each creation session, a session identifier, a reference to an abstract subject, and metadata. The server also defines a work table that stores, for each work, a work identifier, a reference to a session, references to one or more prompt sentences, hierarchical relationships to parent works, and storage references to content.

The server uses a generative AI model client library to send request data to a generative AI model. The generative AI model is implemented as a parameterized neural network with a transformer architecture. The neural network comprises a plurality of attention layers, feed-forward layers, and normalization layers. Each attention layer computes attention scores between tokens of an input sequence using dot products between query vectors and key vectors, followed by softmax normalization. Each feed-forward layer applies linear transformations and non-linear activation functions to intermediate representations. The neural network parameters are stored as floating-point weight matrices and bias vectors. The generative AI model generates output content token by token by repeatedly applying these layers to the current token sequence.

The server uses a set of programs to convert a prompt sentence and context into request data compatible with the generative AI model. For example, the server concatenates a system instruction, previous prompt sentences, and an existing work into a single token sequence and applies a tokenization algorithm, such as a byte-pair encoding algorithm or similar subword segmentation, to produce model input tokens. The server sets model parameters, such as a temperature value, a maximum token length, and stop conditions. The server then includes these tokens and parameters in request data and transmits the request data to a computation resource that executes the generative AI model.

In one example, a user uses the terminal to select an abstract subject such as “Future Cities.” The terminal displays the abstract subject and an input field. The user then inputs a prompt sentence such as:
“Please describe a floating city in the year 2150, focusing on residential buildings and their interaction with nature.”

The terminal transmits this prompt sentence to the server. The server performs a verification operation on the received prompt sentence. The server checks that the character count is within a predetermined limit using string-processing routines, and the server compares substrings against a prohibited-word list stored in the database. If the prompt sentence passes validation, the server stores the prompt sentence in the database with references to the current creation session and the user.

The server then converts the prompt sentence into request data for the generative AI model. The server constructs an input sequence that includes a role-level indication and content, such as a system instruction and the user's prompt sentence. The server performs tokenization of the input sequence and packs the resulting token identifiers into a structured data object. The server also encodes hyperparameters, such as a specified maximum number of output tokens, a sampling temperature, and a nucleus sampling threshold. The server transmits this structured data to the computation resource that executes the transformer-based generative AI model.

The generative AI model receives the token sequence and processes the tokens through multiple self-attention layers and feed-forward layers. At each layer, the model computes attention distributions, multiplies attention weights by value vectors, and updates hidden state vectors. The final layer produces logits representing unnormalized probabilities for the next token. A decoding algorithm, such as top-k or nucleus sampling, then selects the next token based on these logits and the configured temperature. This process repeats until the model reaches a maximum length or a stop token. The computation resource returns the sequence of output tokens to the server.

The server decodes the output tokens back into text to form generated content. The server stores this generated content as a work in the database, associating the work with the creation session and the prompt sentence. The server then generates display data for the work and transmits the display data to the terminal. The terminal renders the text on the display apparatus, enabling the user to view the generated work.

In another example, the user inputs a prompt sentence such as:
“Extend this story by describing how families with children live in this floating city and how public spaces support education and play.”

The terminal transmits the additional prompt sentence to the server with a reference to an existing work. The server retrieves the existing work from the database and constructs contextual information that includes the existing work content and the additional prompt sentence. The server then builds request data for the generative AI model that contains both the existing work embedded as context and the additional prompt sentence as an instruction. The server tokenizes this combined text and computes positional encodings for each token, which are used by the transformer to differentiate positions.

The server sends the contextual request data to the generative AI model. The generative AI model processes the contextual sequence and generates an extended version of the work. The server receives the output, decodes the tokens, and creates a new work record in the database. The server records, in the work table, that this new work is an extended version and stores a reference to the original work as a parent. The server thus maintains a hierarchical relationship between works in the database, for example by using a parent_work_id field and an index on that field to accelerate retrieval of version histories.

The server also performs structured aggregation of evaluation information and viewing counts. When a user on a terminal views a work, the terminal transmits a viewing event to the server. The server increments a viewing count stored in an aggregated statistics table. When a user inputs evaluation information such as a rating or a comment, the server records this information in a feedback table with a work identifier and a user identifier. Periodically or on demand, the server computes popularity information and attention information using numerical algorithms. For example, the server may compute popularity as a weighted sum of normalized viewing counts and average ratings, and may compute attention as a recency-weighted measure that emphasizes recent views or ratings. The server then sorts works using these computed values and stores ranking information. By maintaining pre-computed aggregated values and indices, the server avoids scanning all feedback records for every query, which improves processing speed and scalability.

The server also computes creator statistics. The server aggregates, for each creator, the number of generated works, the average ranking of those works, and cumulative evaluation metrics. The server stores these metrics in a creator statistics table. The server then identifies highly rated creators by applying selection criteria to these stored metrics, such as a threshold on average rating combined with a minimum number of works. The server generates display data for ranking lists and creator summaries and transmits this data to terminals.

The server maintains records for each work that include a creator identifier, generation time information, and summary information of the content. The summary information may be computed as a cryptographic hash value, such as a value produced by a secure hash function. The server uses these records to determine access authority and use conditions. The server defines and enforces access policies, such as restricting access to certain works to particular user groups or preventing modification of finalized versions. When a terminal transmits a work acquisition request, the server checks the requester's identity, compares it against the defined access policy stored in association with the work, and decides whether to transmit the work data. This control reduces the risk of unauthorized access and supports distributed collaboration without exposing sensitive or restricted content.

From a technical perspective, the described server improves computer technology by introducing specific data structures and processing flows that reduce redundant computations and communication overhead. The server maintains creation sessions that bind abstract subjects, prompt sentences, and hierarchically related works in a normalized relational schema. Because of these structures, the server can efficiently reconstruct collaborative editing histories and pass precise contextual subsets to the generative AI model, instead of transmitting entire raw logs of user interactions. This design reduces the size of request data transmitted to the computation resource, which in turn decreases network latency and bandwidth consumption.

The server also offloads complex ranking computations from terminals to the centralized database and computation environment. By using indexed tables and pre-aggregated statistics, the server processes ranking updates using optimized database operations rather than ad hoc client-side operations. This method allows more frequent and fine-grained updates of popularity and ranking information without increasing latency perceived by users. Thus, the system improves responsiveness and scalability over naive architectures that recalculate rankings from raw logs at each query.

The use of a transformer-based generative AI model also provides concrete technical improvements. The model architecture, with multi-head self-attention, enables the server to supply long contextual sequences including multiple prompt sentences and prior work content. The attention mechanism selectively focuses on relevant portions of the context, which results in more coherent and contextually consistent generated content. The server exploits this behavior by systematically constructing context sequences rather than treating each prompt sentence independently. This approach reduces the need for manual editing and patching of generated content and improves the consistency of outputs, thereby reducing the number of model calls required to reach an acceptable final work. This reduction in model calls directly lowers computational load and network traffic between the server and the computation resource.

During training of the generative AI model, a loss function such as cross-entropy is used to measure the difference between predicted token probabilities and actual target tokens. The weights of the transformer layers are updated using gradient-based optimization algorithms.

Data augmentation techniques, such as random masking of tokens or shuffling of segments within defined bounds, are used to improve robustness. The model is trained on a large corpus of diverse text so that it can generalize to the collaborative creation patterns present in the system. Because the server uses a pre-trained model and specializes its use through structured context construction and auxiliary signals such as emotional state information, the system can achieve high-quality outputs with fewer tokens and fewer repetitions than conventional prompt-only usage.

In another embodiment, the server uses emotional state information obtained from the terminal to modify prompt sentences or generate auxiliary information. The terminal may infer an emotional state based on user-input labels, sensor readings, or interaction patterns. The server maps this emotional state to parameter adjustments or additional textual instructions. For example, if the emotional state is “calm,” the server may generate an auxiliary instruction such as “Use a gentle and reflective tone” and append this instruction to the prompt sentence. The server includes this auxiliary instruction in the request data for the generative AI model. This procedure constitutes a rule-based pre-processing step distinct from human manual editing and leverages non-traditional, non-intuitive combinations of emotional signals and control prompts to shape generation behavior. This mechanism enables more precise and automatic modulation of generated content style while reusing the same base model, improving both the expressiveness and computational efficiency of the system. In another variant, the server may incorporate rule-based filters and scoring functions to pre-screen prompt sentences and generated content before storage or display. The server may apply natural language processing techniques, such as keyword matching combined with part-of-speech tagging, to detect problematic or irrelevant content. The server may also assign internal scores based on content length, structural cohesion, and semantic diversity. These scores may be used to automatically flag content for further human review or to adjust ranking computations. This automated pre-screening reduces manual moderation workload and improves consistency of stored data.

The described embodiments show that the server does more than merely speed up human tasks or provide a general-purpose data processing platform. The server defines and enforces specific data structures for sessions, hierarchies, and aggregated statistics; constructs context-aware requests to a transformer-based generative AI model; and integrates feedback-driven ranking with access control and content versioning. These structural and algorithmic elements yield concrete technical effects, such as reduced network traffic, improved retrieval performance, decreased redundant model invocations, and more efficient database operations.

As a result, the system constitutes an improvement to the functioning of the computer system itself, rather than an abstract organization of human creative activity.

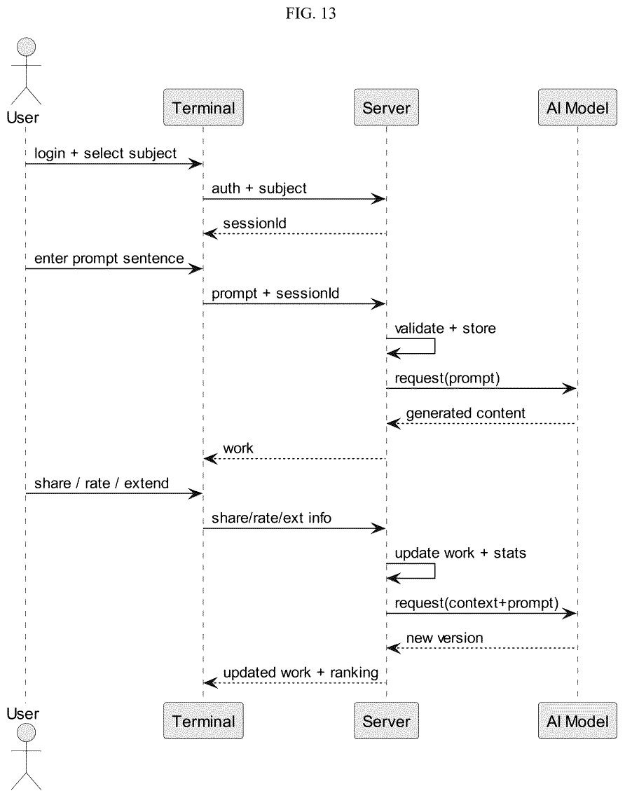

The following describes the processing flow using FIG. 13.

### Step 1:

The terminal displays a login screen and a list of selectable functions.

The user inputs authentication information, such as a user identifier and a password, into the terminal.

The terminal transmits the authentication information to the server as input data.

The server receives the authentication information, compares the user identifier and a hashed version of the password with corresponding records stored in a user table of a database, and determines whether the authentication information matches a stored record.

The server outputs an authentication result, and, when the authentication is successful, the server generates a session token as output data and returns the session token to the terminal.

### Step 2:

The terminal stores the session token in a secure memory area and attaches the session token to subsequent requests as an HTTP header.

The user operates the terminal to request a list of abstract subjects for creation.

The terminal transmits a subject-list request including the session token to the server as input data.

The server verifies the session token, queries a subject table in the database to retrieve records of abstract subjects, and formats the retrieved records into a structured list.

The server outputs a subject list as response data to the terminal.

### Step 3:

The terminal receives the subject list and renders it on a display apparatus as selectable items.

The user selects one abstract subject from the list using an input apparatus such as a touch panel.

The terminal transmits the selected subject identifier and the session token to the server as input data.

The server receives the selected subject identifier, creates a new creation session identifier, and stores a record in a session table that associates the creation session identifier with the selected subject identifier and the user identifier.

The server outputs the creation session identifier to the terminal.

### Step 4:

The terminal receives the creation session identifier and switches the display to a prompt-sentence input screen.

The user inputs a prompt sentence into a text field of the terminal, for example:
“Please describe a floating city in the year 2150, focusing on residential buildings and their interaction with nature.”

The terminal transmits the prompt sentence, the creation session identifier, and the session token to the server as input data.

The server receives the prompt sentence and the creation session identifier, checks the prompt sentence length using string-length operations, and scans the prompt sentence for prohibited expressions by comparing substrings against a prohibited-word list stored in a filter table.

The server outputs a validation result and, when the prompt sentence passes validation, inserts a record into a prompt table that associates the prompt sentence with the creation session identifier and the user identifier.

### Step 5:

The server constructs request data for a generative AI model by combining a system instruction and the prompt sentence into a single text sequence.

The server applies a tokenization algorithm to the text sequence to convert characters into a sequence of token identifiers, and sets model parameters such as a maximum number of output tokens and a temperature value.

The server outputs a model-input object that includes token identifiers and model parameters as request data, and transmits this request data to a computation resource that executes the generative AI model.

The generative AI model processes the token identifiers through multiple transformer layers, computing self-attention scores and updating hidden vectors layer by layer, and generates output token identifiers representing generated content.

The computation resource outputs these token identifiers to the server as response data.

### Step 6:

The server receives the output token identifiers from the computation resource and decodes the identifiers back into text using a detokenization algorithm.

The server treats the decoded text as generated content for a work and creates a new work identifier.

The server inserts a record into a work table that associates the work identifier with the creation session identifier, the prompt sentence identifier, and the generated content, and may compute a cryptographic hash of the generated content using a hash function and store the hash as summary information.

The server outputs display data including the generated content and the work identifier to the terminal.

### Step 7:

The terminal receives the display data and renders the generated content in a reading area on the display apparatus.

The user views the generated content and decides whether to keep, modify, or extend the work.

If the user chooses to share the work, the user operates a share button on the terminal.

The terminal transmits a share request including the work identifier, a desired visibility setting, and the session token to the server as input data.

The server receives the share request, verifies that the requesting user is authorized to share the work, updates the corresponding record in the work table by setting a visibility flag, and inserts notification records into a notification table for other users.

The server outputs notification data to terminals of other users via a push or polling mechanism.

### Step 8:

Another user operates a terminal to open a list of shared works.

The terminal transmits a shared-work-list request including the session token to the server as input data.

The server verifies the session token, queries the work table for records whose visibility flag permits viewing by this user, and optionally joins with a ranking table to order the works based on popularity information.

The server outputs a structured list of shared works to the terminal.

The terminal renders the list and allows the user to select a specific work.

When the user selects a work, the terminal transmits a work-detail request including the work identifier and the session token to the server as input data, and the server responds with detailed work content and metadata as output data.

### Step 9:

The other user views the work on the terminal and may input evaluation information such as a rating, and comment information such as feedback text.

The terminal transmits the rating value, the comment text, the work identifier, and the session token to the server as input data.

The server validates that the rating is within an allowed range and that the comment length is within limits, and inserts a feedback record into a feedback table, associating the feedback with the work identifier and the user identifier.

The server updates aggregated statistics by incrementing counters and recomputing averages, for example using a weighted average calculation in a statistics table.

The server outputs updated popularity or ranking values to a ranking module that can later be supplied to terminals.

### Step 10:

The other user may also input an additional prompt sentence to extend or revise the work, for example:
“Extend this story by describing how families with children live in this floating city and how public spaces support education and play.”

The terminal transmits the additional prompt sentence, the base work identifier, and the session token to the server as input data.

The server retrieves the base work content from the work table using the base work identifier, concatenates the base work content and the additional prompt sentence into a combined context sequence, and labels portions of the sequence as context and instruction.

The server tokenizes the combined context sequence, sets context-aware parameters such as a higher maximum token count, and constructs contextual request data for the generative AI model.

The server outputs this contextual request data to the computation resource as new request data.

### Step 11:

The generative AI model receives the contextual request data, processes the base work content and the additional prompt sentence together through the transformer layers, and generates an output token sequence representing an extended or revised version of the work. The computation resource outputs the extended token sequence to the server.

The server decodes the token sequence into extended content text and creates a new work identifier for the extended version.

The server inserts a record into the work table that associates the new work identifier with the base work identifier as a parent, thereby forming a parent-child relationship that encodes hierarchical versioning.

The server outputs display data for the extended version to both the first user's terminal and the participating user's terminal so that both users can view the updated work.

### Step 12:

The server continuously monitors viewing events for each work.

When a terminal displays a work, the terminal transmits a viewing event containing the work identifier and optionally a timestamp to the server as input data.

The server increments a viewing count in a statistics table for that work and may store a summarized log for auditing.

The server periodically executes ranking computation by reading evaluation information and viewing counts for all or selected works, calculating popularity information as a function of viewing counts and rating averages, and calculating attention information by applying recency weighting to recent interactions.

The server sorts works based on these metrics and writes ranking information into a ranking table as output data.

### Step 13:

The server aggregates creator statistics by reading the ranking table and the work table.

The server groups works by creator identifier, computes metrics such as total number of works, average ranking position, cumulative evaluation scores, and total viewing counts, and writes these metrics into a creator-statistics table.

The server applies selection rules, such as thresholds on average score and minimum work count, to identify highly rated creators.

The server outputs creator-ranking data and highlight flags to terminals, enabling terminals to display lists of highly rated creators and associated works.

### Step 14:

The server generates and maintains records for access control.

When a work is created or a version is added, the server creates a record that includes the creator identifier, the generation time, and summary information such as a cryptographic hash of the work content.

The server stores this record in an access-control table and associates it with policy information such as permitted user groups and usage limitations.

When a terminal sends a work acquisition request, the server uses the user identifier derived from the session token and the requested work identifier as input data, looks up the corresponding access-control record, compares the requester's attributes with the stored policy, and determines whether access is allowed.

The server outputs either the requested work data or an access-denied response depending on this determination.

### Step 15:

In an embodiment that uses emotional state information, the terminal obtains emotional state labels from the user, such as “calm,” “excited,” or “sad,” and transmits the emotional state label along with a prompt sentence to the server as input data.

The server maps the emotional state label to one or more auxiliary instructions, such as “Use a gentle and reflective tone” or “Emphasize dynamic and energetic descriptions,” based on a predefined mapping table.

The server appends the auxiliary instruction to the prompt sentence or encodes it as a separate control field in the request data for the generative AI model.

The server outputs modified request data that includes both the original prompt sentence and the auxiliary instruction, thereby adjusting style or tone of the generated content in a rule-based manner without manual rewriting by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation platforms that use a generative AI model typically treat user input as static text and simply forward a prompt sentence to the model. Such platforms generally (i) do not incorporate real-time user emotion into the generation pipeline, (ii) do not correct biased user evaluations caused by transient emotions, and (iii) do not provide a unified control flow that connects generation, cooperative refinement, popularity computation, creator identification, rights management, and notification. As a result, several technical problems arise in the operation of computer-implemented content generation and distribution systems.

First, on the generation side, a conventional server only performs straightforward request-response processing: it receives a prompt, calls a generative AI model, and returns the output. The server does not dynamically adjust model input or model parameters based on user-side signals such as facial expression, voice tone, or sentiment of text. Consequently, the processing logic of the generative AI model is not tailored to the real-time state of the user, leading to sub-optimal utilization of computing resources and a lower quality of generated outputs, for example by failing to adapt generation length, detail level, or style to the user's current needs.

Second, on the evaluation and ranking side, conventional systems directly aggregate raw ratings and raw view counts to compute popularity and ranking. They do not consider that a user's instantaneous emotional state (for example, excited, frustrated, or sad) can systematically bias evaluation values. The server thus performs ranking based on distorted input signals, which degrades the quality of the ranking data structure stored and maintained in the system. Such distortion propagates through database records and cache layers, causing inaccurate ordering of contents and creators and reducing the reliability of any server-side recommendation algorithms that depend on this ranking.

Third, existing systems often handle collaboration, sharing, and notifications as separate modules that are loosely coupled. For instance, a collaboration tool may maintain its own versioning, while a ranking service stores independent view and rating counters, and a notification service monitors a separate event stream. This fragmentation causes redundant data maintenance, increased synchronization overhead, and inconsistencies among stored states. It also prevents the server from efficiently generating and distributing real-time share identifiers and notifications that are consistently tied to up-to-date ranking information and rights information.

Fourth, conventional platforms typically lack integrated server-side mechanisms for managing user consent regarding rights to generated objects. Rights waivers, if handled at all, are implemented as static legal notices rather than as structured, queryable consent records bound to particular generated objects and user accounts in the storage system. As a result, the server cannot programmatically control sharing and reuse of generated objects at a fine granularity, which complicates automated distribution workflows and increases the risk of unauthorized usage.

Accordingly, there is a need for an improved computer-implemented system that (i) acquires and analyzes user emotion information, and uses it to adjust prompt sentences and generation conditions in real time, (ii) acquires emotion information at the time of evaluation and uses it to correct evaluation values before storing them, (iii) computes and updates popularity, attention, ranking, and popular-creator information on the server side based on the corrected data, and (iv) manages sharing identifiers and rights-waiver consent information in an integrated manner so that distribution and notification processes can be controlled consistently. Such improvements should be realized as concrete modifications to the server's data processing logic, memory structures, and communication flows, thereby improving the operation of computer systems that execute generative AI-based content generation and distribution.

The specific processing by the specific processing unit 290 of the data processing device 12 in Application Example 2 is realized by the following means.

The present invention provides a server comprising a processor and a storage device, the processor being configured to execute instructions that cause the server to (i) receive, from a first user via a user terminal, a prompt sentence for instructing a generative AI model to generate a generated object based on a specified topic, and receive, from one or more participating users via one or more user terminals, generation instructions including the prompt sentence, display generated object information output from the generative AI model, receive modification instructions for changing the prompt sentence based on the generated object information, and iteratively update the generated object until the generated object is completed through cooperative generation processing among the users; (ii) analyze the prompt sentence and the modification instructions, generate a final prompt sentence according to the specified topic and one or more generation conditions, convert the final prompt sentence into an input format acceptable by the generative AI model, and transmit the converted final prompt sentence to the generative AI model; (iii) acquire user information including at least one of facial expression information, audio information, and text information from the one or more user terminals, estimate an emotional state of a user based on the user information, and, in accordance with the emotional state, dynamically correct at least one of the final prompt sentence and the one or more generation conditions of the generative AI model so as to adjust content of the generated object or a generation process of the generated object; (iv) record evaluation information and viewing information input by other users for the generated object, calculate popularity information and attention information of the generated object based on the evaluation information and the viewing information, and generate ranking information by ranking the generated object in accordance with at least one of the popularity information and the attention information; (v) acquire, by using the estimation of the emotional state, an emotional state of an evaluating user at a time of input of the evaluation information, and adjust an evaluation value to be used in calculating at least one of the popularity information and the attention information by correcting the evaluation value in accordance with the emotional state; (vi) store the generated object and the ranking information in the storage device, generate sharing identification information for each generated object, and, via the sharing identification information, control sharing of the generated object so that the generated object is distributable in real time to other user terminals; and (vii) acquire consent information indicating whether or not a user waives right information associated with a generated object generated by the user at a time of use of the system, store the consent information as right management information in the storage device, and control at least one of sharing and utilization of the generated object in accordance with the consent information. This enables the server to modify core data flows and state transitions within the content generation platform so that generation, evaluation, ranking, sharing, and rights management are executed in an integrated, emotion-aware manner, thereby improving the accuracy of ranking data, the adaptability and efficiency of generative AI processing, and the reliability of automated sharing and notification operations performed by the computer system.

The term “system” refers to an arrangement including at least one server, at least one user terminal, a processor, and a storage device, which cooperatively perform the processing operations described in the claims.

The term “processor” refers to a hardware processing unit, such as a central processing unit or other computing circuitry, configured to execute instructions to perform the functions recited in the claims.

The term “storage device” refers to a non-transitory computer-readable medium, such as a memory or mass storage apparatus, configured to store data, programs, generated objects, ranking information, and right management information.

The term “user terminal” refers to an electronic device operated by a user, such as a computing device with an input interface and a display interface, configured to transmit information to and receive information from the server.

The term “first user” refers to a user who initially provides a prompt sentence to instruct the generative AI model to generate a generated object based on a specified topic.

The term “participating user” refers to a user other than the first user who inputs generation instructions or modification instructions and cooperates in completing the generated object.

The term “generative AI model” refers to a computational model that uses machine learning to generate new content data, such as text data or image data, in response to an input prompt sentence.

The term “prompt sentence” refers to text information including at least one instruction that specifies conditions or content for generation of a generated object by the generative AI model.

The term “generation instruction” refers to information including at least a prompt sentence or a modified version of the prompt sentence, which is supplied to the generative AI model to cause generation or updating of a generated object.

The term “modification instruction” refers to information that changes or supplements a previously input prompt sentence based on generated object information, and which is used to iteratively refine the generated object.

The term “generated object” refers to digital content, such as text content or visual content, that is output by the generative AI model in response to a prompt sentence or generation instruction.

The term “generated object information” refers to data representing at least a portion of a generated object or metadata associated with the generated object, which is used for display or further processing.

The term “specified topic” refers to subject matter or a conceptual theme designated by a user and used as a basis for controlling generation by the generative AI model.

The term “generation condition” refers to a parameter or control value, such as style, length, level of detail, or processing constraint, used to control a generation operation of the generative AI model.

The term “final prompt sentence” refers to a prompt sentence that has been generated or modified by the processor based on one or more inputs, including user-provided text and generation conditions, and that is formatted for input to the generative AI model.

The term “user information” refers to information acquired from a user terminal, including at least one of facial expression information, audio information, and text information, which is used to estimate an emotional state of a user.

The term “facial expression information” refers to visual data or features derived from an image or video of a user's face, which are used to infer an emotional state.

The term “audio information” refers to sound data or features derived from a user's voice, which are used to infer an emotional state.

The term “text information” refers to character data, such as typed messages or comments, which are used to infer sentiment or an emotional state.

The term “emotional state” refers to a state of a user's affect, such as joy, sadness, excitement, or calmness, estimated from user information and used to adjust processing by the server.

The term “evaluation information” refers to data representing feedback from a user regarding a generated object, such as a rating value, a like indication, or a comment.

The term “viewing information” refers to data representing access behavior for a generated object, such as view counts, view timestamps, or viewing duration.

The term “evaluation value” refers to a numerical or categorical value derived from evaluation information, which is used to calculate popularity information or attention information.

The term “popularity information” refers to a measure of popularity of a generated object, calculated based on at least evaluation information and viewing information.

The term “attention information” refers to a measure of attention or interest in a generated object, calculated based on at least viewing dynamics, such as recent views or changes in views.

The term “ranking information” refers to information indicating an order or rank of one or more generated objects based on at least one of popularity information and attention information.

The term “popular creator” refers to a user who is identified based on ranking information as having created at least one generated object with high popularity information or high attention information.

The term “creator information” refers to information related to a user who has created a generated object, such as an identifier, a name, or profile data.

The term “new generation information” refers to information indicating that a new generated object has been created, and including at least an identifier, summary, or time associated with the new generated object.

The term “sharing identification information” refers to identification data, such as a link or token, that uniquely associates with a generated object and is used to control or enable sharing of the generated object.

The term “sharing” refers to making a generated object available from the server to one or more other user terminals using sharing identification information.

The term “right information” refers to information relating to intellectual property or usage rights associated with a generated object.

The term “consent information” refers to information indicating whether a user agrees to waive or retain right information associated with a generated object generated by the user.

The term “right management information” refers to structured data representing consent information and other right information, which is used by the server to control sharing and utilization of generated objects.

The term “notification information” refers to information transmitted from the server to a user terminal for the purpose of notifying a new generated object, a ranking status, or creator-related events.

The term “access information” refers to information indicating that a user terminal has requested posting, viewing, or other access to a generated object.

The term “display control” refers to operations performed by the processor to cause display of information, such as creator information or new generation information, on one or more user terminals.

The term “cooperative generation processing” refers to processing in which multiple users iteratively submit prompt sentences and modification instructions, and the generative AI model generates or updates a generated object based on such submissions until completion.

In one embodiment, a system includes a server, one or more user terminals, a storage device, and a network interface. The server includes at least one processor and memory storing program instructions. The terminals include at least one input device, at least one output device, and at least one sensor such as a camera and microphone. The server and the terminals are interconnected via a communication network such as the Internet.

The server executes an operating system such as a general-purpose server operating system, a web application framework such as a generic web framework, and one or more machine learning frameworks such as a general numerical computation framework or a general deep learning framework. The server also executes an application program implementing the functions described in the claims. The application program is stored on a non-transitory computer-readable storage medium and loaded into the memory of the server.

The terminal executes an operating system such as a mobile operating system or a desktop operating system and a client application implemented as a native application or a web browser application. The terminal application displays user interface screens, acquires user inputs, captures sensor data including images and audio of the user, and transmits such data to the server using a network protocol such as HTTPS.

The server manages multiple data structures in the storage device. In one example, the server stores user records including user identifiers, authentication data, and consent information regarding rights to generated objects. The server stores project records including project identifiers, specified topics, and generation conditions for each project. The server stores prompt records including raw prompt sentences provided by users, modification instructions, and final prompt sentences generated by the server. The server stores generated object records including object identifiers, references to binary content stored in object storage, metadata such as topic and creator, and ranking information such as popularity values and attention values. The server stores evaluation records including rating values, comments, and emotional states at the time of evaluation. The server stores rights management records that associate each generated object with consent information indicating whether rights have been waived.

The server uses a generative AI model to generate content in response to prompt sentences. In one embodiment, the generative AI model is implemented as a transformer-based neural network for text generation or as a diffusion-based or transformer-based neural network for image generation. The transformer-based model includes an embedding layer, multiple attention layers, and feed-forward layers. The embedding layer converts token IDs into embedding vectors. The attention layers compute weighted combinations of these vectors using attention weights derived from key, query, and value matrices. The feed-forward layers apply non-linear transformations to these vectors.

The server trains or fine-tunes the generative AI model using a training dataset stored in the storage device. The server uses a loss function such as cross-entropy for text generation or a denoising loss for image generation. The server updates model parameters using an optimization algorithm such as stochastic gradient descent with momentum or an adaptive gradient method. During training, the server performs forward passes to compute model outputs and loss values, backward passes to compute gradients, and weight updates according to the optimization algorithm. The server may apply data augmentation techniques such as random cropping, random noise addition, or token dropout to increase robustness and reduce overfitting.

The server executes an emotion estimation model to estimate user emotional states from user information. In one embodiment, the server uses a convolutional neural network for facial expression analysis and a recurrent or transformer-based network for audio and text-based sentiment analysis. The convolutional neural network receives normalized facial images, extracts feature maps through convolutional and pooling layers, and outputs class probabilities for emotion categories such as joy, sadness, anger, and calmness. The audio model receives spectrogram features or mel-frequency cepstral coefficients computed from user voice signals and outputs emotion probabilities. The text-based model receives tokenized comment text and outputs sentiment values. The server combines these outputs using a weighted fusion strategy to estimate a final emotional state label and a confidence score. The server processes prompt sentences received from the terminals. The terminal displays an input field on a screen and acquires a prompt sentence from a user. The user may input, for example, the following prompt sentence:
“Please design a building with sky gardens in a future city.”

In another example, the user may input:
“Please generate a bright-colored visual of a future city with floating parks.”

In still another example, the user may input:
“Please explain how to rank works by popularity based on user ratings and view counts and display the top work and its creator.”

The terminal transmits the prompt sentence and associated metadata such as project identifier and user identifier to the server. The server parses the prompt sentence using a natural language processing library. The server performs tokenization, normalization, and syntactic or semantic analysis as needed. The server stores the parsed representation in the prompt records.

The server then composes a final prompt sentence by combining the parsed user prompt, project context, and generation conditions. The server retrieves the specified topic and any stored constraints for the project. The server also retrieves the current emotional state of the user if emotion-based generation is enabled. When the emotional state indicates joy, the server adds a rule indicating that the generated content should be vivid and optimistic. When the emotional state indicates sadness, the server adds a rule indicating a calmer or darker tone. The server inserts such rules as additional text or as control tokens in the final prompt sentence.

For example, when the user is joyful and has provided the prompt sentence “Please design a building with sky gardens in a future city.”, the server may generate a final prompt sentence such as:
“Please design a bright, optimistic building with sky gardens in a future city, emphasizing vivid colors and a cheerful atmosphere.”

The server encodes the final prompt sentence into the input format required by the generative AI model. For a transformer-based text model, the server converts the sentence into a sequence of token IDs and packs these into tensors. For an image generation model, the server may use the final prompt sentence as a textual condition for conditioning a diffusion process or a transformer-based image generator.

The server also adjusts generation conditions based on emotional state and system conditions. The server may modify a sampling temperature parameter, sequence length, diffusion steps, or guidance scale to control diversity, detail, and generation time. For example, when the user is excited, the server reduces the number of diffusion steps or the sequence length to obtain faster but coarser outputs. When the user is calm, the server increases these parameters to obtain more detailed and refined outputs. This dynamic parameter selection algorithm differs from fixed-parameter pipelines and improves computational efficiency by allocating resources according to user state.

The server forwards the encoded final prompt sentence and generation parameters to the generative AI model. The model performs internal computations as defined by its architecture. The server receives generated content, decodes it to text or visual data, and stores it as a generated object in the storage device. The server assigns a generated object identifier and stores a reference to its binary representation in an object storage system. The server further creates sharing identification information, such as a unique token or URL, and associates it with the generated object.

The terminal receives generated object information from the server and displays it to the user. The user can then decide to accept the generated object, request a new generation with a different prompt sentence, or refine the prompt sentence. For refinement, the user may input, for example:
“Please add a public park on the rooftop with holographic trees.”

The terminal sends this modification instruction to the server, which appends it to the existing prompt history and produces a new final prompt sentence to be fed to the generative AI model. This iterative refinement continues until the generated object is deemed completed by the users.

The server collects evaluation information and viewing information for each generated object. When another user views a generated object via a user terminal, the terminal sends viewing information including object identifier and time of access to the server. When the user evaluates the generated object, the terminal sends evaluation information such as a numeric rating, a like indicator, and an optional textual comment.

The server estimates the emotional state of the evaluating user at the time of evaluation using the emotion estimation model. The server then corrects the evaluation value based on the emotional state. For example, when the user is unusually excited and assigns a maximum rating, the server slightly reduces the effective rating to counteract the bias. When the user is unusually sad and assigns a very low rating, the server slightly increases the effective rating. The server uses a correction function that maps raw evaluation values and emotional labels to adjusted values. This correction function is stored and executed as part of the server logic and can be preconfigured or learned from historical data.

The server periodically computes popularity information and attention information from the stored evaluation information and viewing information. The server retrieves relevant data from the storage device and calculates metrics such as average adjusted rating, number of evaluations, total views, recent views, and growth rates. The server then calculates popularity and attention scores using predetermined formulas. The server stores these scores in the generated object records and determines ranking positions of all generated objects. The server also aggregates scores by creator identifier to determine popular creators.

The server generates ranking information for user display. The terminal requests ranking pages and the server responds with ordered lists of generated objects and creator summaries. The terminal displays concepts such as “Top Popular Works” or “Popular Creators” based on the ranking information. The server can also generate notification information when a popular creator creates a new generated object. The server identifies users who have previously interacted with this creator's generated objects and sends notification information to their terminals. The terminals display notifications prompting users to view the new generated object.

The server manages consent information and rights management information. When a user first uses the system or posts a generated object, the terminal displays a dialog asking the user whether the user agrees to waive rights associated with generated objects. The user selects an option, and the terminal transmits consent information to the server. The server stores this information as part of rights management records. When the server receives a request to share or reuse a generated object, the server consults the rights management records and either allows or restricts such operations according to consent information. This structured management enables automated yet controlled distribution while reducing the risk of unauthorized use.

The system provides technical effects beyond mere automation of human tasks. By integrating emotion-based modification of prompt sentences and generation parameters, the server dynamically adapts neural network behavior to user state. This adaptation leads to more efficient use of computation resources, because fast, coarse inference is automatically selected in contexts where detailed output is less critical, and more detailed inference is reserved for contexts with calm users, thereby balancing latency and quality. By correcting evaluation values using emotional state, the server reduces systematic noise in stored evaluation data, improving the accuracy of ranking data structures and, consequently, server-side recommendation algorithms. This effect manifests as a measurable reduction in ranking volatility and a closer alignment between long-term user engagement and stored popularity metrics.

The use of explicit data structures for final prompt sentences, generation conditions, emotional states, and rights management information allows the server to perform deterministic and auditable computations, which improves data consistency and reduces redundant recalculation of popularity metrics. The described correction and aggregation procedures are not performed by mere manual processing, but rely on the server's ability to execute specific mathematical transformations and maintain synchronized states across multiple modules.

The generative AI model and the emotion estimation model operate according to training rules and inference rules that differ from human heuristics. The server applies non-intuitive parameter schedules, such as emotion-dependent sampling temperature curves or non-linear rating correction functions, which exploit the models' statistical properties. These techniques improve technical performance metrics such as generation latency, output diversity under fixed hardware constraints, and ranking accuracy under noisy user feedback conditions. In alternative embodiments, the server may employ different neural network architectures, such as encoder-decoder transformers, convolutional architectures, or recurrent networks. The emotion model may use additional features, such as physiological sensor signals, and the fusion method may use a probabilistic graphical model instead of a weighted sum. The generative AI model may generate audio content, three-dimensional geometry content, or mixed media content instead of or in addition to text and images. The server may be configured to execute on a cluster of machines, using distributed training and inference, while maintaining the same logical flow of operations described above.

In all embodiments, the server, the terminals, and the described data structures cooperate to implement an integrated, emotion-aware, rights-aware generative content platform. The described architecture, algorithms, and control flows improve the functioning of the computer system itself by enhancing the efficiency, accuracy, and reliability of generative AI processing, data storage, ranking computation, and notification control compared to conventional systems that treat user prompts and evaluations as static, emotion-independent data.

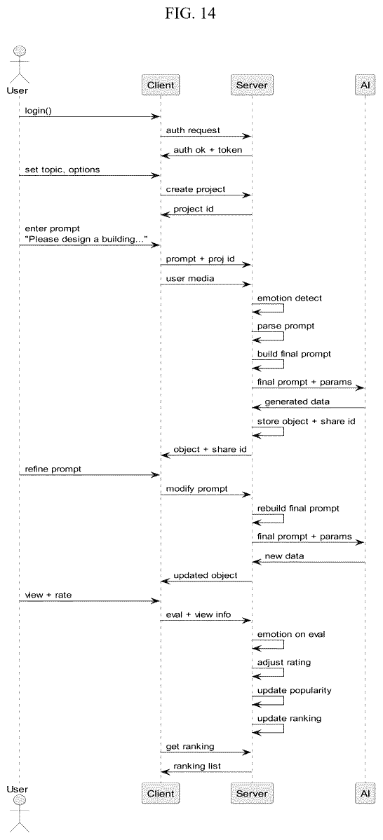

The following describes the processing flow using FIG. 14.

### Step 1:

User operates the terminal to execute a login operation and to input authentication information.

The input is user identification information and password data entered via an input interface of the terminal.

The terminal transmits the authentication information to the server via a communication interface.

The output of the terminal is an authentication request message including user ID and password.

### Step 2:

Server receives the authentication request message and performs user authentication.

The input is the authentication request including user ID and password.

The server compares the received credentials with user records stored in a user table in the storage device, performs a hash comparison for the password, and determines whether the user is valid.

The output is either an authentication success message including a session token or an authentication failure message sent to the terminal.

### Step 3:

Terminal receives the authentication success message and stores the session token locally.

The input is the authentication success message from the server.

The terminal updates its internal session state with the session token and activates a main application screen.

The output is a logged-in UI displayed to the user, including options to set a topic, to enter a prompt sentence, and to configure generation.

### Step 4:

Terminal acquires consent information regarding rights waiver from the user.

The input is user interaction with a consent dialog presented on the display.

The user selects whether or not to waive rights associated with generated objects by pressing a button or selecting a menu item.

The terminal constructs a consent message including the chosen option and the session token as output and transmits the message to the server.

### Step 5:

Server receives the consent message and records rights management information.

The input is the consent message including user identifier and consent choice.

The server writes a record into a rights management data structure, associating the user ID with a rights-waiver flag, and confirms that this flag will be referenced when controlling sharing and reuse of generated objects.

The output is an acknowledgment message indicating that consent information has been stored.

### Step 6:

User operates the terminal to set a specified topic and generation conditions.

The input is user-entered topic text and optional parameters such as desired style, length, or deadline.

The terminal performs basic validation on text length and parameter ranges and generates a project creation request containing the topic, conditions, and session token.

The output is the project creation request transmitted to the server.

### Step 7:

Server receives the project creation request and registers a project record.

The input is the project creation request including topic and generation conditions.

The server generates a unique project identifier, stores the topic and conditions in a project table, and links the project to the user ID.

The output is a project creation response containing the project identifier sent back to the terminal.

### Step 8:

Terminal presents a prompt sentence input interface tied to the project.

The input is the project identifier and project context received from the server.

The terminal updates the UI to show an editable text field labeled for a prompt sentence associated with the current topic.

The output is a visual interface that allows the user to type a prompt sentence.

### Step 9:

User inputs a prompt sentence for the generative AI model.

The input is text entered via the keyboard or voice-to-text interface of the terminal.

For example, the user may input the prompt sentence “Please design a building with sky gardens in a future city.” or “Please generate a bright-colored visual of a future city with floating parks.”

The output is a prompt submission action, in which the terminal packages the prompt sentence, project identifier, and session token into a message.

### Step 10:

Terminal transmits the prompt sentence to the server.

The input is the user-entered prompt sentence and associated metadata.

The terminal encodes the prompt as character data, attaches the project identifier and session token, and sends the data via a secure protocol to the server.

The output is a prompt submission request available to be processed by the server.

### Step 11:

Terminal captures user information for emotion estimation in parallel with prompt submission.

The input is sensor signals from a camera, a microphone, or other sensors while the user is entering or confirming the prompt sentence.

The terminal converts raw image frames into compressed image data and converts raw audio signals into audio frames or features such as spectrograms.

The output is user information data including facial expression information and audio information, which the terminal sends to the server or to an emotion analysis service.

### Step 12:

Server receives the prompt submission request and logs raw prompt data.

The input is the prompt submission message including the prompt sentence and project identifier.

The server stores the raw prompt sentence, time stamp, and user ID into a prompt record table, and marks the status as “pending analysis.”

The output is a stored raw prompt record and an internal reference ID associated with this prompt.

### Step 13:

Server receives user information for emotion estimation and executes an emotion estimation model.

The input is user information including at least one of facial expression information, audio information, and text information.

The server normalizes image sizes and color channels, computes feature maps through convolutional layers, converts audio to spectral features, and feeds these features into pre-trained neural networks to compute emotion probabilities.

The output is an emotional state label such as joy, sadness, or calmness, along with a confidence value stored in an emotion record linked to the prompt.

### Step 14:

Server performs natural language processing on the raw prompt sentence.

The input is the raw prompt sentence retrieved from the prompt record.

The server tokenizes the text into a sequence of tokens, normalizes casing and punctuation, and performs syntactic or semantic parsing as required to detect key entities and constraints.

The output is an internal structured representation of the prompt sentence used for subsequent composition of a final prompt sentence.

### Step 15:

Server composes a final prompt sentence based on topic, generation conditions, and emotional state.

The input is the structured prompt representation, the project topic and generation conditions from the project record, and the emotional state label and confidence.

The server applies a rule set that adds descriptive clauses or control tokens according to the emotional state and conditions, and concatenates the topic, user input, and rule-based modifications into a single final prompt sentence.

The output is a final prompt sentence suitable for input to the generative AI model, for example “Please design a bright, optimistic building with sky gardens in a future city, emphasizing vivid colors and a cheerful atmosphere.”

### Step 16:

Server converts the final prompt sentence into a model-specific input format.

The input is the final prompt sentence as plain text.

For a transformer-based model, the server maps each token to a token ID according to a vocabulary, pads or truncates the sequence to a specified length, and packs the token IDs into a tensor data structure. For an image generator, the server may embed the text into a fixed-dimensional vector space.

The output is one or more tensors or numerical vectors representing the final prompt sentence.

### Step 17:

Server selects generation conditions for the generative AI model based on emotional state and system load.

The input is the emotional state label, project conditions, and current system resource metrics such as CPU/GPU load.

The server computes values for parameters such as sampling temperature, maximum token length, or number of diffusion steps using a parameter selection algorithm that increases detail for calm states and reduces latency for excited states.

The output is a parameter set used to control the generative AI model during inference.

### Step 18:

Server invokes the generative AI model to generate content.

The input is the tensor representation of the final prompt sentence and the parameter set. The server performs a forward pass through the model: it multiplies tensors with weight matrices, applies activation functions, computes attention scores, and iteratively samples output tokens or image features according to the configured parameters.

The output is generated object data, such as a sequence of output tokens for text or an image tensor for visual content.

### Step 19:

Server decodes and formats the generated object.

The input is generated object data in internal model format.

For text, the server converts token IDs to characters and merges them into a human-readable string. For images, the server converts tensors into pixel values and encodes them into an image file format.

The output is a generated object in a consumable digital format and associated metadata.

### Step 20:

Server stores the generated object and associates it with records in the storage device.

The input is the generated object and metadata including project identifier, user identifier, final prompt sentence, and emotional state.

The server assigns a generated object identifier, writes a generated object record to a database, and stores the object binary in object storage. The server also initializes counters for evaluations and views.

The output is a stored generated object record and a stable reference to the content.

### Step 21:

Server generates sharing identification information for the generated object.

The input is the generated object identifier and associated record.

The server constructs a unique link or token that encodes or references the object identifier, and stores this sharing identification in a sharing table.

The output is sharing identification information that can be distributed to user terminals for immediate access.

### Step 22:

Server transmits generated object information and sharing identification to the terminal of the creator.

The input is the generated object record and sharing identification information.

The server packages metadata (title, topic, creator ID, emotional tag) and a content URL into a response message and sends it to the terminal.

The output is a response that allows the terminal to display the generated object and to present the share link.

### Step 23:

Terminal receives the generated object information and renders it to the user.

The input is the response message from the server.

The terminal downloads the object binary if necessary, decodes it, and displays the text or image on the screen along with controls to accept, regenerate, refine, or share.

The output is a visual presentation of the generated object and interactive elements for further actions.

### Step 24:

User reviews the generated object and optionally refines the prompt sentence.

The input is the displayed generated object.

The user decides whether additional features or modifications are desired and enters a new refinement prompt such as “Please add a public park on the rooftop with holographic trees.” in the terminal interface.

The output is a new modification instruction provided to the terminal.

### Step 25:

Terminal transmits the modification instruction to the server for iterative generation.

The input is the refinement prompt text and current project and object identifiers.

The terminal bundles this information into a modification request and sends it to the server.

The output is a modification request that triggers another round of prompt analysis and content generation by the server.

### Step 26:

Server repeats prompt analysis, emotion estimation, final prompt composition, and generative AI invocation for the modification instruction.

The input is the modification request and any newly captured user information.

The server updates the prompt history, may re-estimate the emotional state, composes an updated final prompt sentence, converts it into model input, and runs the generative AI model to create a revised generated object.

The output is an updated generated object associated with a new version entry in the generated object records.

### Step 27:

User operates a terminal to view and evaluate generated objects created by any user.

The input is a list of objects or ranking information displayed on the terminal.

The user selects an object to view, then provides evaluation information such as a rating and a comment via the evaluation interface.

The output is evaluation information and viewing information sent from the terminal to the server.

### Step 28:

Server collects evaluation information and viewing information for each generated object.

The input is evaluation messages and view logs from terminals.

The server stores ratings, likes, comments, and view counts in evaluation records and updates counters in the corresponding generated object records.

The output is updated evaluation and viewing data for later popularity computation.

### Step 29:

Server estimates the emotional state of the evaluating user at the time of evaluation.

The input is user information captured during evaluation, which can include facial expression, audio, and evaluation comment text.

The server processes these inputs through emotion estimation models, computes emotion probabilities, and selects a dominant emotional state label and intensity.

The output is an emotional state record linked to each evaluation event.

### Step 30:

Server corrects evaluation values based on the emotional state.

The input is the raw evaluation value and the emotional state record.

The server applies a correction function that maps the combination of raw rating and emotional category into an adjusted rating, for example by slightly down-scaling ratings under strong joy and slightly up-scaling ratings under strong sadness.

The output is an adjusted evaluation value stored alongside the raw value in the evaluation record.

### Step 31:

Server computes popularity information and attention information for each generated object. The input is adjusted evaluation values, counts of evaluations, view counts, and time-based access data retrieved from the storage device.

The server calculates aggregate values such as average adjusted rating, weighted rating with respect to the number of evaluations, and time-weighted view metrics. The server then combines these values using predefined formulas to compute popularity and attention scores.

The output is updated popularity information and attention information for each generated object, stored in the generated object records.

### Step 32:

Server generates ranking information based on computed popularity and attention scores. The input is the popularity and attention scores for all generated objects.

The server sorts generated objects according to these scores using sorting algorithms and composes ranking lists for categories such as overall top, topic-specific, or time-window-limited rankings.

The output is ranking information including ordered lists of generated objects and associated scores.

### Step 33:

Server identifies popular creators and prepares notification information.

The input is ranking information and creator identifiers associated with highly ranked generated objects.

The server aggregates scores by creator, identifies creators exceeding a popularity or attention threshold, and generates creator-level summaries and new-generation events.

The output is creator information and new-generation information used to notify followers or interested users.

### Step 34:

Server transmits ranking information and popular creator information to terminals.

The input is ranking lists and creator summaries.

The server sends structured data representing these lists to terminals requesting ranking pages or subscribed to creator updates.

The output is messages enabling terminals to render ranking views, highlight popular creators, and display new-generation notifications.

### Step 35:

Terminal receives ranking information and displays it to users.

The input is ranking and creator information from the server.

The terminal formats the lists, shows thumbnails, titles, creator names, and popularity indicators, and provides navigation controls to open details or follow creators.

The output is a visual ranking interface that guides users to popular or relevant generated objects.

### Step 36:

Server controls sharing and utilization of generated objects according to rights management information.

The input is requests to share, reuse, or distribute generated objects and corresponding rights management records including consent information.

The server checks whether rights have been waived or restricted, and, based on this determination, either generates accessible sharing identification information and distribution URLs or returns an error or restriction message.

The output is controlled sharing behavior that enforces rights policies at the server level.

### Step 37:

Server uses sharing identification information to deliver generated objects in real time to other user terminals.

The input is valid sharing identification information included in access requests from terminals.

The server resolves the identification information to the associated generated object record, retrieves content and metadata, and sends them through the network without unnecessary intermediate lookups or manual routing.

The output is low-latency data streams of generated objects delivered to multiple terminals simultaneously, enabling real-time collaborative viewing or editing.

### Step 38:

Server periodically updates internal indices and caches to optimize performance of generation, evaluation, and ranking.

The input is accumulated data regarding generated objects, evaluation events, and access patterns.

The server recalculates frequent-access indices, precomputes portions of ranking lists, and updates in-memory caches for popular objects, thereby reducing future query time and CPU load.

The output is an improved system state in which subsequent requests for popular or recently updated data are served with reduced latency and fewer disk accesses.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

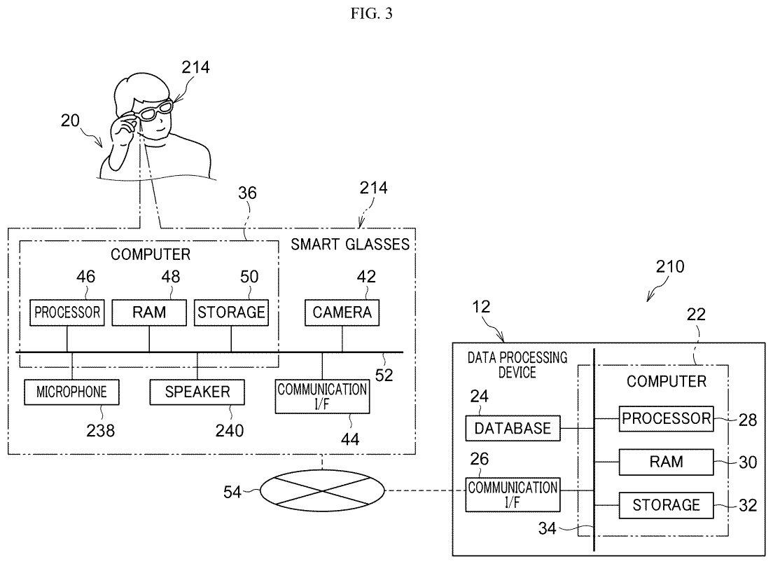

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

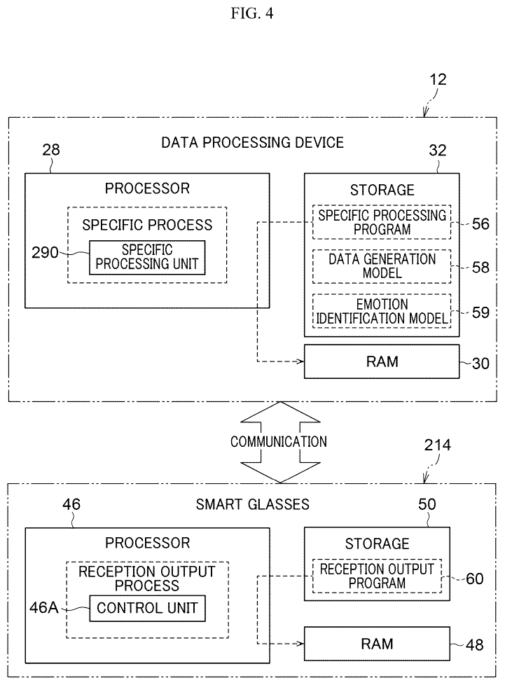

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

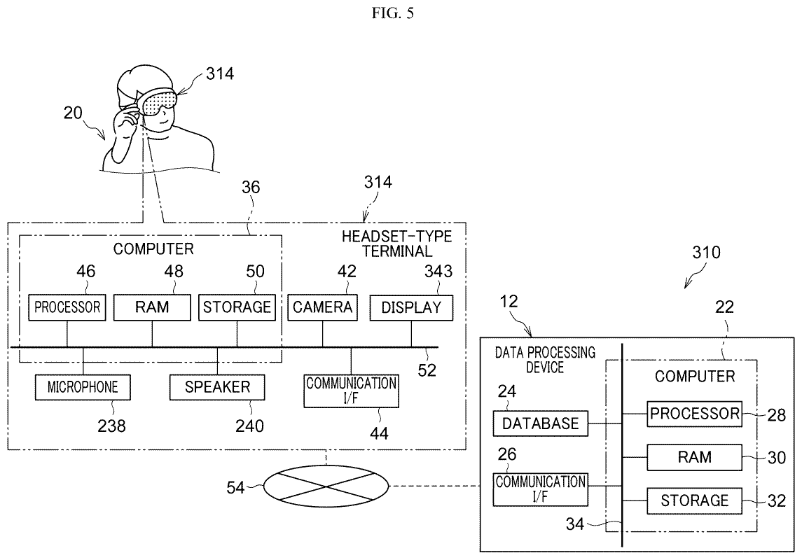

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

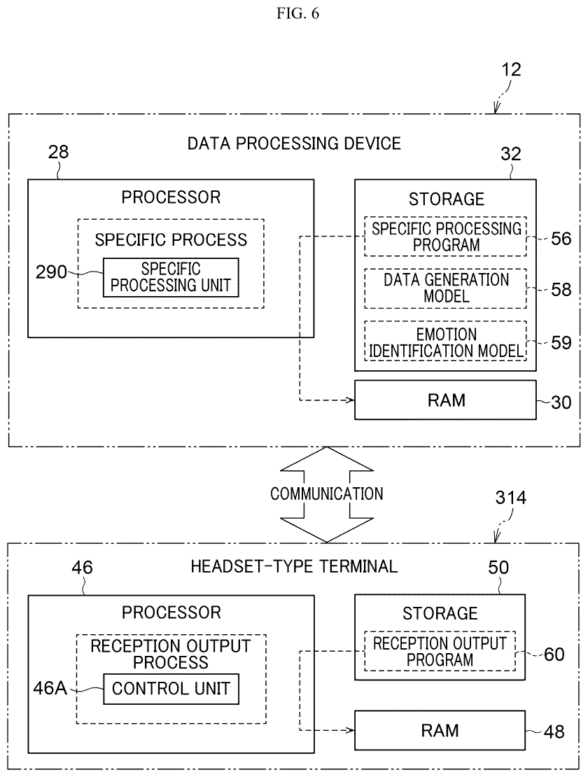

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

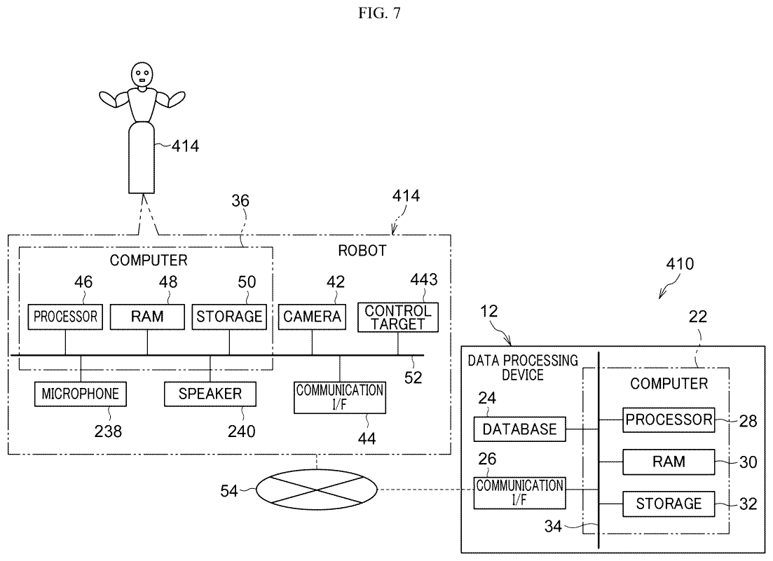

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

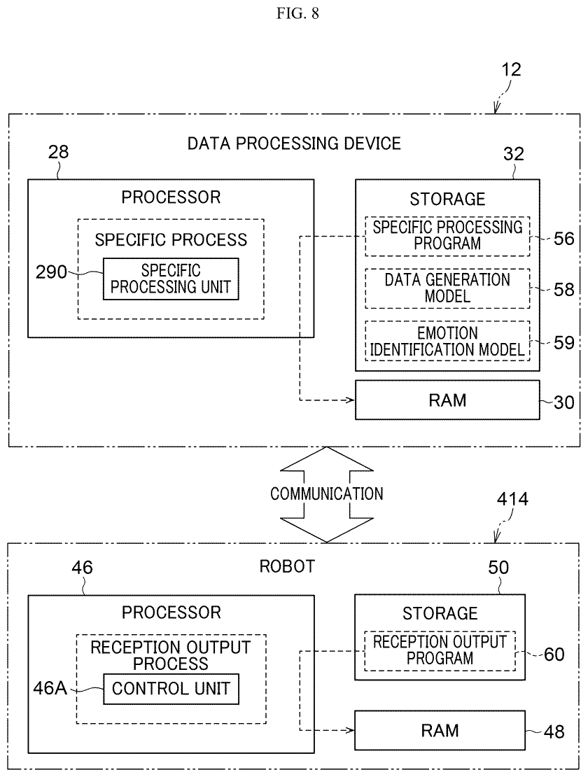

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

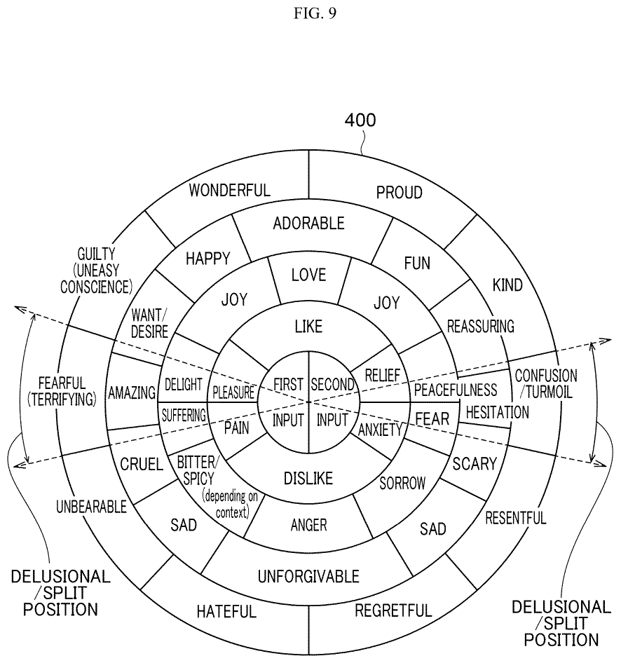

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

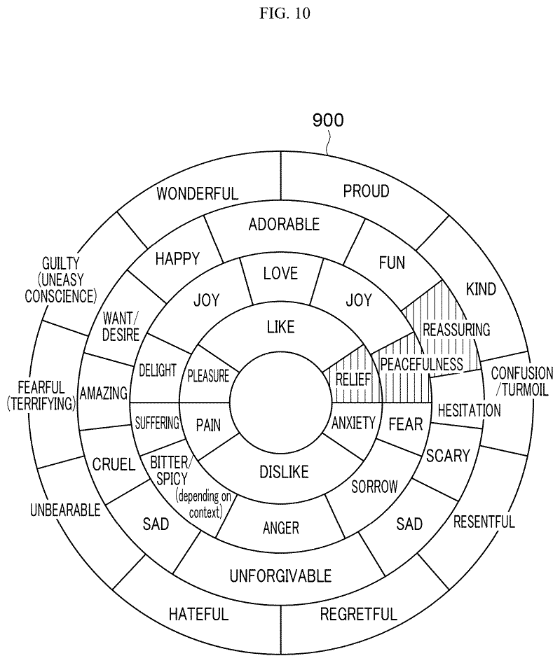

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal including a display apparatus and an input apparatus connected to an information processing apparatus, setting information input by a user as creation content, the setting information including at least a theme, a work unit, and a period, and store the setting information in a storage apparatus,
analyze and normalize the received setting information, determine a structure of a generation instruction based on the theme, the work unit, and the period, and generate, according to the structure, a prompt sentence in which the theme, the work unit, and the period are embedded, convert the prompt sentence into generation instruction data for input to a generative AI model, transmit the generation instruction data including the prompt sentence to the generative AI model through a communication apparatus, and acquire work data generated by the generative AI model based on the prompt sentence,
transmit the acquired work data to the terminal through the communication apparatus so that the work data is displayed on the display apparatus,
when the user performs a correction input of at least one of the setting information and the prompt sentence through the terminal, repeat processing of generating the prompt sentence and processing of causing the generative AI model to generate the work data based on the correction input,
calculate, for a plurality of items of work data generated by the generative AI model, a popularity index based on at least evaluation information and browsing information acquired from one or more terminals, and generate ranking information in which the plurality of items of work data are ranked based on the popularity index,
transmit, to the terminal, display data including work data having a high popularity index and creator information corresponding to the work data, based on the ranking information, so that the work data and the creator information are displayed on the display apparatus, and
acquire state information of the user from at least one of the terminal and a sensor apparatus, estimate an emotional state of the user based on the state information, and change at least one of content of the prompt sentence and generation conditions of the generation instruction data according to the emotional state and transmit the changed generation instruction data to the generative AI model.

### (Supplementary 2)

The system according to supplementary 1,
wherein the processor is configured to
aggregate creators for each item of the work data based on the ranking information, calculate the popularity index for each creator, specify a popular creator based on the popularity index, and transmit, to the terminal, display data indicating the popular creator so that the popular creator is displayed on the display apparatus.

### (Supplementary 3)

The system according to supplementary 1,
wherein the processor is configured to
classify the emotional state of the user by using at least one of input operation information acquired from the terminal, line-of-sight information with respect to the display apparatus, and biological information acquired from the sensor apparatus, generate a prompt sentence in which at least one of instruction content, output form, and level of detail relating to support for creation of a work is adjusted according to the emotional state, and input the prompt sentence to the generative AI model.

### Application Example 1

### (Supplementary 1)

A system comprising a processor,
wherein the processor is configured to
receive, from a user terminal, theme information, work-unit information, and period information, and generate a prompt sentence for content generation based on the theme information, the work-unit information, and the period information, and input the prompt sentence into a generative artificial intelligence model,
obtain story information output from the generative artificial intelligence model, analyze the story information, and convert the story information into structured script information including a plurality of scene items, character items, and imaging items,
control image-generation software based on the structured script information, set three-dimensional scene information and time information, and automatically generate image data, convert the image data into viewing-format image data, store the viewing-format image data as distribution image data that is transmittable to the user terminal via a network, and manage reference information to the distribution image data,
calculate an index value for each work based on viewing-count information and evaluation information for the distribution image data, and generate ranking information of works or creators based on the index value, and
accept an input instruction of the prompt sentence by an initial user and an additional prompt input to the generative artificial intelligence model by a participating user, accept a correction instruction for at least one of the image data and the structured script information, and update at least one of the prompt sentence and the structured script information while causing the work to be completed by collaborative editing.

### (Supplementary 2)

The system according to supplementary 1,
wherein the processor is configured to display, in a list format, at least one of the distribution image data and creator information based on the ranking information.

### (Supplementary 3)

The system according to supplementary 1,
wherein the processor is configured to estimate an emotional state of a user based on at least one of biological information and behavior information acquired from the user terminal, modify instruction content included in at least one of the prompt sentence and the structured script information in accordance with the emotional state, and transmit the modified instruction content to the generative artificial intelligence model.

### Example 2

### (Supplementary 1)

A system comprising a processor,
wherein the processor is configured to
cause a terminal including a display apparatus to present, via a communication network, a list of multiple abstract subjects for creation and to receive, from a user operating the terminal, a selection of one of the abstract subjects and to store the selection in a storage apparatus, generate, on the basis of the selected abstract subject, identification information for a creation session, associate the identification information with the abstract subject in the storage apparatus, and cause the terminal to display an input screen for a prompt sentence corresponding to the creation session,
receive, from a first user via the terminal, a prompt sentence based on the abstract subject, the prompt sentence being input to instruct a generative AI model to generate a work, and store the prompt sentence in association with the creation session and the first user in the storage apparatus,
perform a verification process on the received prompt sentence, the verification process including at least checking a character length and presence of prohibited terms, convert the verified prompt sentence into request data for input to an external generative AI model, and transmit the request data to a computation resource that provides the generative AI model, receive, from the generative AI model, generated content that is a response to the request data, store the generated content as a work in association with the creation session and the prompt sentence in the storage apparatus, and cause the terminal to display the work by transmitting display data of the work to the terminal,
receive, from a participating user via a terminal, at least one of evaluation information, comment information, and an additional prompt sentence with respect to the work, and store the received information in association with the work in the storage apparatus,
construct, when the additional prompt sentence is received, new request data for the generative AI model including at least contextual information containing content of the work and the additional prompt sentence, transmit the new request data to the generative AI model, receive a response from the generative AI model, generate on the basis of the response at least one of an extended version and a revised version of the work, store the at least one of the extended version and the revised version in the storage apparatus in a hierarchical relationship with an original version of the work, and share the at least one of the extended version and the revised version with the first user and the participating user by transmitting corresponding display data to their terminals,
calculate, on the basis of at least the evaluation information and a viewing count for each work, at least one of popularity information and attention information for each work, generate ranking information among the works, calculate and store statistical values related to each creator on the basis of the ranking information in the storage apparatus,
extract, on the basis of at least one of the ranking information and the statistical values, a highly rated creator, and generate data for causing a terminal to output information regarding the highly rated creator,
and create, for each work and version management information thereof, a record including at least a creator identifier, generation time information, and summary information of content data, determine, on the basis of the record, at least one of access authority and use condition of the work, and control, according to a result of the determination, whether to provide work data in response to a work acquisition request from a terminal.

### (Supplementary 2)

The system according to supplementary 1,
wherein the processor is configured to
record, in the storage apparatus for each creation session, a correspondence between each prompt sentence input to the generative AI model and generated content output from the generative AI model, and provide, to a terminal, data for displaying a cooperative editing history by multiple users on the basis of the correspondence.

### (Supplementary 3)

The system according to supplementary 1,
wherein the processor is configured to
obtain, from the terminal, information indicating an emotional state of a user, generate, on the basis of the emotional state information, at least one of auxiliary information and a modification instruction for a prompt sentence, and include the at least one of the auxiliary information and the modification instruction in request data transmitted to the generative AI model so as to cause the generative AI model to generate a work in accordance with the emotional state.

### Application Example 2

### (Supplementary 1)

A system comprising a processor,
wherein the processor is configured to
receive, from a first user via a user terminal, a prompt sentence for instructing a generative AI model to generate a generated object based on a specified topic,
receive, from one or more participating users via one or more user terminals, generation instructions including the prompt sentence with respect to the generative AI model, display generated object information output from the generative AI model, receive modification instructions for changing the prompt sentence based on the generated object information, and iteratively update the generated object until the generated object is completed through cooperative generation processing among the first user and the one or more participating users,
analyze the prompt sentence and the modification instructions input to the generative AI model, generate a final prompt sentence in accordance with the specified topic and one or more generation conditions, convert the final prompt sentence into an input format acceptable by the generative AI model, and transmit the converted final prompt sentence to the generative AI model,
acquire, from the one or more user terminals, user information including at least one of facial expression information, audio information, and text information, estimate an emotional state of a user based on the user information, and, in accordance with the emotional state, dynamically correct at least one of the final prompt sentence and the one or more generation conditions of the generative AI model so as to adjust content of the generated object or a generation process of the generated object,
record evaluation information and viewing information input by other users for the generated object, calculate popularity information and attention information of the generated object based on the evaluation information and the viewing information, and generate ranking information for the generated object by ranking the generated object in accordance with at least one of the popularity information and the attention information,
acquire, by using the estimation of the emotional state, the emotional state of an evaluating user at a time of input of the evaluation information, and adjust an evaluation value to be used in calculating at least one of the popularity information and the attention information by correcting the evaluation value in accordance with the emotional state of the evaluating user, store the generated object and the ranking information in a storage device, generate sharing identification information for each generated object, and, via the sharing identification information, control sharing of the generated object so that the generated object is distributable in real time to other user terminals, and
acquire consent information indicating whether or not a user waives right information associated with a generated object generated by the user at a time of use of the system, store the consent information as right management information, and control at least one of sharing and utilization of the generated object in accordance with the consent information.

### (Supplementary 2)

The system according to supplementary 1,
wherein the processor is configured to identify, based on the ranking information, a creator who has created a generated object having at least one of high popularity information and high attention information as a popular creator, and perform display control for notifying creator information relating to the popular creator and new generation information relating to a newly generated object created by the popular creator to other user terminals.

### (Supplementary 3)

The system according to supplementary 1,
wherein the processor is configured to, in response to acquisition of access information from a user terminal for posting or viewing the generated object, acquire new generation information relating to a newly generated object created by a popular creator identified based on the ranking information, and transmit notification information including the new generation information to the user terminal so as to prompt viewing of the newly generated object created by the popular creator.

What is claimed is:

1. A system comprising:
circuitry configured to:
receive, via a communication interface coupled to a packet-switched network, setting information from a terminal device, the setting information comprising at least a theme parameter, a work unit parameter, and a period parameter, and store and normalize the setting information in a memory;
determine a structure of a generation instruction based on the normalized setting information, generate a prompt sentence by embedding the theme parameter, the work unit parameter, and the period parameter into the determined structure, and convert the prompt sentence into generation instruction data for input to a generative AI model;
transmit the generation instruction data to the generative AI model via the communication interface, acquire work data generated by the generative AI model based on the prompt sentence, and transmit the work data to the terminal device;
detect a correction input comprising at least one of a modification to the setting information or a modification to the prompt sentence received from the terminal device, and in response, regenerate an updated prompt sentence and cause the generative AI model to regenerate work data based on the corrected information; and
calculate, for a plurality of items of work data generated by the generative AI model, a popularity index based on evaluation information and browsing information acquired from one or more terminal devices, generate ranking information in which the plurality of items of work data are ranked based on the popularity index, and transmit display data comprising work data having a high popularity index and creator information associated with the work data to the terminal device.

2. The system according to claim 1, wherein the circuitry is configured to aggregate creator information for each item of work data based on the ranking information, calculate the popularity index for each creator, and transmit display data indicating a popular creator to the terminal device.

3. The system according to claim 2, wherein the circuitry is configured to compute the popularity index as a weighted combination of the evaluation information and the browsing information, wherein the weights are adjustable parameters stored in the memory.

4. The system according to claim 3, wherein the circuitry is configured to periodically recompute the ranking information based on updated evaluation information and browsing information received from the one or more terminal devices, and update the display data transmitted to the terminal device accordingly.

5. The system according to claim 4, wherein the circuitry is configured to store the ranking information and creator information as time-series data in the memory, enabling retrieval of historical ranking states for analysis.

6. The system according to claim 1, wherein the circuitry is configured to acquire state information of the user from at least one of the terminal device and a sensor apparatus via the communication interface, estimate an emotional state of the user based on the state information, and modify at least one of content of the prompt sentence and generation conditions of the generation instruction data according to the emotional state prior to transmitting the generation instruction data to the generative AI model.

7. The system according to claim 6, wherein the circuitry is configured to classify the emotional state of the user based on at least one of input operation information acquired from the terminal device, line-of-sight information with respect to a display apparatus, and biological information acquired from the sensor apparatus.

8. The system according to claim 7, wherein the circuitry is configured to generate an emotion-adapted prompt sentence in which at least one of an instruction parameter, an output format specification, and a level-of-detail parameter is adjusted based on the classified emotional state.

9. The system according to claim 1, wherein the circuitry is configured to receive participation requests from a plurality of terminal devices, assign each participating user a shared session identifier, and coordinate iterative prompt input and work data review across the plurality of terminal devices within the shared session.

10. The system according to claim 9, wherein the circuitry is configured to track prompt contributions from each participating user within the shared session, associate each contribution with a contributor identifier, and store contribution records in the memory.

11. The system according to claim 10, wherein the circuitry is configured to apply a merging algorithm to combine prompt contributions from multiple participating users into a unified prompt sentence, resolving conflicts based on a priority rule stored in the memory.

12. The system according to claim 1, wherein the setting information further comprises at least one of a style parameter, a format parameter, and a quality constraint parameter, and wherein the generation instruction structure incorporates the style parameter and the format parameter as embedded constraints in the prompt sentence.

13. The system according to claim 1, wherein the work data comprises at least one of text data, image data, audio data, and video data generated by the generative AI model.

14. The system according to claim 13, wherein the circuitry is configured to obtain story information from the generative AI model, analyze the story information, and convert the story information into structured script information comprising a plurality of scene items, character items, and imaging items.

15. The system according to claim 14, wherein the circuitry is configured to control image generation processing based on the structured script information, set scene configuration information and timing information, and automatically generate image data from the structured script information.

16. The system according to claim 15, wherein the circuitry is configured to convert the image data into a distribution format and store the converted image data in the memory as distribution content data.

17. The system according to claim 1, wherein the circuitry is configured to record an execution log comprising each prompt sentence and the corresponding work data for each invocation of the generative AI model within a session, and store the execution log in the memory.

18. A system comprising:
circuitry configured to:
receive setting information comprising a theme parameter, a work unit parameter, and a period parameter from a terminal device via a communication interface, and generate a prompt sentence by normalizing the setting information and embedding the parameters into a determined generation instruction structure;
transmit generation instruction data comprising the prompt sentence to a generative AI model, acquire work data generated by the generative AI model, and iteratively regenerate the prompt sentence based on correction inputs from the terminal device;
calculate a popularity index for each of a plurality of items of work data based on evaluation information and browsing information, generate ranking information based on the popularity index, and transmit display data comprising high-popularity work data and creator information to the terminal device; and
acquire state information of a user, estimate an emotional state based on the state information, and adjust generation conditions of the generation instruction data based on the emotional state.

19. The system according to claim 18, wherein the circuitry is configured to classify the emotional state based on at least one of input operation information, line-of-sight information, and biological information from a sensor apparatus, and generate an emotion-adapted prompt sentence with adjusted instruction parameters.

20. A method comprising:
receiving, via a communication interface coupled to a packet-switched network, setting information from a terminal device, the setting information comprising at least a theme parameter, a work unit parameter, and a period parameter, and storing and normalizing the setting information in a memory;
determining a structure of a generation instruction based on the normalized setting information, generating a prompt sentence by embedding the theme parameter, the work unit parameter, and the period parameter into the determined structure, and converting the prompt sentence into generation instruction data for input to a generative AI model;
transmitting the generation instruction data to the generative AI model via the communication interface, acquiring work data generated by the generative AI model based on the prompt sentence, and transmitting the work data to the terminal device;
detecting a correction input comprising at least one of a modification to the setting information or a modification to the prompt sentence received from the terminal device, and in response, regenerating an updated prompt sentence and causing the generative AI model to regenerate work data based on the corrected information; and
calculating, for a plurality of items of work data generated by the generative AI model, a popularity index based on evaluation information and browsing information acquired from one or more terminal devices, generating ranking information in which the plurality of items of work data are ranked based on the popularity index, and transmitting display data comprising work data having a high popularity index and creator information associated with the work data to the terminal device.
